(19) United States
(12) Patent Application Publication
(10) Pub. No.: US 2024/0367180 A1
(43) Pub. Date: Nov. 7, 2024

(54) INCREASING FLOTATION RECOVERY AND THROUGHPUT

(71) Applicant: VIRGINIA TECH INTELLECTUAL PROPERTIES, INC., Blacksburg, VA (US)

(72) Inventors: Roe-Hoan YOON, Blacksburg, VA (US); Kaiwu HUANG, Blacksburg, VA (US); Mohit GUPTA, Blacksburg, VA (US); Christopher Aaron Noble, Blacksburg, VA (US)

(21) Appl. No.: 18/692,153

(22) PCT Filed: Sep. 16, 2022
(86) PCT No.: PCT/US2022/076622

§ 371 Date: Mar. 14, 2024

Related U.S. Application Data
(60) Provisional application No. 63/244,926, filed on Sep. 16, 2021.
(60) Provisional application No. 63/244,935, filed on Sep. 16, 2021.

(51) Int. Cl. B03D 1/02; B03D 1/14; B03D 1/24; C02F 1/24; C02F 101/20; C22B 3/22; C22B 15/00

(52) U.S. Cl. CPC B03D 1/025; B03D 1/028; B03D 1/24; C02F 1/24; C22B 3/22; C22B 15/0086; B03D 1/1425; B03D 2203/04; C02F 2101/20; C02F 2301/046

(57) ABSTRACT

Various examples are provided in relation to improved recovery and throughput of both fine and coarse particulate materials. In one example, a method includes injecting an aqueous suspension of a cloud of small air bubbles into an aqueous phase including fine particulate materials, wherein the fine particulate material is selectively hydrophobized and collected by small air bubbles; allowing the bubbles to rise in the aqueous phase; and collecting the air bubbles to obtain a concentrate of the fine particulate materials. In another example, a method includes adding a hydrophobizing agent to an aqueous phase to render coarse particulate material selectively hydrophobic; allowing air bubbles to attach to the coarse particulate material and changing the apparent specific gravity of the coarse particulate materials so a layer of one type of coarse particle is formed on top; allowing the one type of coarse particles to float and enter the forth phase.

### CROSS REFERENCE TO RELATED APPLICATIONS

This application claims priority to, and the benefit of, U.S. provisional application entitled “Increasing Flotation Throughput and Recovery by Improving Fine Particles Recovery” having Ser. No. 63/244,926, filed Sep. 16, 2021, and U.S. provisional application entitled “Increasing Flotation Throughput by Improving Coarse Particles Recovery” having Ser. No. 63/244,935, filed Sep. 16, 2021, both of which are hereby incorporated by reference in their entireties.

### STATEMENT REGARDING FEDERALLY SPONSORED RESEARCH OR DEVELOPMENT

This invention was made with government support under Grant No. DE-FE0029900 awarded by the United States Department of Energy. The Government has certain rights in the invention.

### BACKGROUND

Copper is one of the most widely used metals after iron and aluminum to support the growing economies around the world. It was initially used 10,000 years ago for making everything from coins to ornaments. Today, the red metal is widely used for building construction (43%), electrical and electronic products (20%), transportation equipment (20%), consumer and general products (10%), and industrial machinery and equipment (7%). Its demand has been growing by 2.8% annually since 1960, which is slightly below the annual world GDP growth rate of 3.5%. However, it is anticipated that the demand will accelerate when electrical vehicles (EVs) displace internal combustion engine vehicles (ICEVs) and more electricity is generated from renewable resources such as offshore windmills and solar panels.

In 2018, the mining industry produced 21 million metric tonnes (Mt) of refined copper, most of which (82%) was extracted from low-grade porphyry-type copper ores with the rest extracted from the ores of sedimentary origin. It does not appear that copper will run out in the foreseeable future. The world reserve based on company's reported data is 830 million Mt, while a 2014 USGS report suggested 2.1 billion tons of identified copper resource plus 5 billion tons of yet-to-be discovered resources. While the resource is sizeable, the average grade of the copper ores has been declining by 1.8% per year over the past 12 years, reaching a global average of 0.59% Cu in 2017. In the same year, the average copper grades in Chile and the U.S. were 0.66 and 0.33%, respectively. The declining ore grades caused the global net cash cost to be three-times higher in 2017 than the levels seen in 2000.

The major costs in the mining and processing of low-grade ores are due to the embodied energy costs. It has been reported that 18% of the energy required for producing primary copper goes to mining, 42% to mineral processing, 27% to smelting, 7% to refining, and 3% to tailings disposal. It has been shown also that the embodied energy required for mining and mineral processing increases with declining ore grades, partly because lower-grade ores are often fine-grained and hence require finer grinding for liberation.

### SUMMARY

Aspects of the present disclosure are related to improving flotation recovery and throughput in conjunction with a first principle mathematical model that can predict plant performance on the basis of the mineral liberation characteristics of an ore. In one aspect, among others, a method of separating one type of fine particulate materials from other types of materials dispersed in an aqueous phase comprises injecting an aqueous suspension of a cloud of small air bubbles of less than 500 microns into an aqueous phase comprising one type of fine particulate material, wherein the one type of fine particulate material is hydrophobized and the one type of fine particulate material is selectively collected by the air bubbles; allowing the air bubbles loaded with the one type of fine particulate material to rise in the aqueous phase; and collecting the air bubbles loaded with the one type of fine particulate material thereby obtaining a low-grade concentrate of the one type of fine particulate material. In various aspects, the air bubbles can be less than 400 microns, less than 300 microns, less than 250 microns, less than 200 microns, or smaller.

In one or more aspects, the method can comprise processing the low-grade concentrate of the one type of fine particulate material in a flotation process to generate a high-grade concentrate of the one type of fine particulate material. The method can comprise rendering the one type of fine particulate material selectively hydrophobized prior to inclusion in the aqueous phase. The one type of fine particulate material can be rendered selectively hydrophobic by surface treatment. The surface treatment can utilize a long-chain surfactant as a hydrophobizing agent. When the one type of fine particulate material comprises a sulfide mineral, the surface treatment can comprise adding a thiol-type reagent to the aqueous phase for hydrophobization. The method can comprise separating the one type of fine particulate material using the cloud of small air bubbles in a cyclonic flotation system.

In various aspects, the method can comprise determining performance of a flotation plant for separation of the one type of fine particulate material from other types of fine particles, the performance determined based upon a flotation model that determines grade versus recovery curves for the one type of fine particulate material from mineral liberation characteristics; and adjusting operation of the steps of claim 1 based upon the determined performance. Operating conditions of the flotation plant can be modified by optimizing recirculation of the one type of fine particulate material remaining in the aqueous phase.

In another aspect, a method of separating one type of fine particulate materials from other types of materials dispersed in an aqueous phase comprises adding a recyclable hydrophobic liquid to an aqueous phase comprising one type of fine particulate material while being agitated, wherein the one type of fine particulate material is selectively hydrophobized and the one type of fine particulate material is selectively collected by the hydrophobic liquid; allowing droplets of the hydrophobic liquid loaded with the one type of fine particulate material to rise in the aqueous phase and flow into a separate vessel; agitating, in the separate vessel, the hydrophobic liquid comprising the one type of particulate material dispersed in the hydrophobic liquid to allow any aqueous phase that may have been entrained into the hydrophobic liquid phase to settle along with other types of materials that remain hydrophilic at a bottom of the separate vessel; and separating the hydrophobic liquid from the one type of fine particulate material and recycling the hydrophobized liquid for subsequent use, thereby obtaining a high-grade concentrate of the one type of fine particulate material separated from the other types of materials.

In one or more aspects, the method can comprise rendering the one type of fine particulate material selectively hydrophobized prior to inclusion in the aqueous phase. The one type of fine particulate material can be rendered selectively hydrophobic by surface treatment. The surface treatment can utilize a long-chain surfactant as a hydrophobizing agent. When the one type of fine particulate material comprises a sulfide mineral, the surface treatment can comprise adding a thiol-type reagent to the aqueous phase for hydrophobization. The method can comprise separating the one type of fine particulate material using the cloud of small air bubbles in a cyclonic flotation system. In various aspects, the recyclable hydrophobic liquid can be selected from short-chain alkanes with carbon numbers less than seven, and an organic solvent whose boiling point is below the boiling point of water, allowing separation from the one type of fine particulate material by steam tripping or application of a low level of heat treatment for recycling and sustainability.

In another aspect, a method of separating one type of coarse particulate materials from other types of materials dispersed in an aqueous phase comprises adding a hydrophobizing agent to an aqueous phase comprising coarse particulate materials to selectively render one type of coarse particulate material hydrophobic; feeding the aqueous phase comprising the coarse particulate materials to a flotation cell configured to push the coarse particulate materials upward with accelerative forces and pull the coarse particulate materials downward with decelerative forces while allowing air bubbles to attach to the one type of coarse particulate material that is selectively hydrophobized and thereby reducing the apparent specific gravity of the one type of coarse particulate material and form a layer of froth phase; allowing the coarse particulate materials in the flotation cell to form a layer of particulate materials with the one type of coarse particulate material on top of the layer of particulate materials; allowing the one type of coarse particulate material to enter the froth phase via the accelerative forces, wherein the one type of coarse particulate material is upgraded via froth cleaning action provided by the froth phase; and separating the one type of coarse particulate material from the froth phase and thereby obtaining the one type of coarse particulate material separated from other types of coarse particles.

In one or more aspects, the method can comprise rendering the one type of coarse particulate material hydrophobic prior to inclusion in the aqueous phase. The one type of coarse particulate material can be rendered selectively hydrophobic by surface treatment. The surface treatment can utilize a long-chain surfactant as a hydrophobizing agent. When the one type of coarse particulate material comprises a sulfide mineral, the surface treatment can comprise adding a thiol-type reagent to the aqueous phase for hydrophobization. In various aspects, the method can comprise determining performance of a flotation plant for separation of the one type of coarse particulate material from other types of coarse particulate materials, the performance determined based upon a flotation model that determines grade versus recovery curves of the one type of coarse particulate material from mineral liberation characteristics; and adjusting operation of the steps of claim 16 based upon the determined performance.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B illustrate examples of flotation rate constants and recovery by entrainment, in accordance with various embodiments of the present disclosure.

FIG. 2 illustrates a comparison of length scales of solvent extraction (SX), mineral flotation, and HHS technology, in accordance with various embodiments of the present disclosure.

FIG. 3 illustrates an example of a hydrophobic-hydrophilic separation (HHS) process, in accordance with various embodiments of the present disclosure.

FIG. 4 illustrates an example of a process for fine particle recovery, in accordance with various embodiments of the present disclosure.

FIG. 5 illustrates an example of closed circuit flotation with CST, in accordance with various embodiments of the present disclosure.

FIG. 6 illustrates examples of contact angles, in accordance with various embodiments of the present disclosure.

FIGS. 7A and 7B illustrate an example of fine particle recovery using cyclonic flotation, in accordance with various embodiments of the present disclosure.

FIGS. 8A and 8B illustrate examples of closed and open CST circuit simulation results, in accordance with various embodiments of the present disclosure.

FIG. 9 illustrates an example of a process for coarse particle recovery, in accordance with various embodiments of the present disclosure.

FIGS. 10A-10C illustrate examples of coarse particle separation results, in accordance with various embodiments of the present disclosure.

FIG. 11 illustrates an example of coarse particle grade recovery, in accordance with various embodiments of the present disclosure.

FIGS. 12A-12C illustrate examples of force measurement apparatus and curves, in accordance with various embodiments of the present disclosure.

FIGS. 13A and 13B illustrate an example of disjoining pressure isotherms for a wetting film of water on an OTS-coated silica surface, in accordance with various embodiments of the present disclosure.

FIGS. 14A and 14B illustrate examples of hydrophobic force constants, in accordance with various embodiments of the present disclosure.

FIG. 15 illustrates examples of energy barriers for interactions between bubbles and particles, in accordance with various embodiments of the present disclosure.

FIG. 16 illustrates mass and flow balances across pulp and froth phases of a floatation cell, in accordance with various embodiments of the present disclosure.

FIG. 17 illustrates an example of a flotation circuit for simulation, in accordance with various embodiments of the present disclosure.

FIGS. 18 and 19 illustrate examples of size-by-class recoveries, in accordance with various embodiments of the present disclosure.

FIG. 20A and 20B illustrate simulated froth recoveries, in accordance with various embodiments of the present disclosure.

FIG. 21 illustrates an example of the effect of froth height on pulp phase rate constant, in accordance with various embodiments of the present disclosure.

FIG. 22 illustrates an example of recovery vs. grade, in accordance with various embodiments of the present disclosure.

FIGS. 23A and 23B illustrate examples of size-by-class distributions, in accordance with various embodiments of the present disclosure.

FIG. 24 illustrates an example of a five-cell rougher flotation bank, in accordance with various embodiments of the present disclosure.

FIGS. 25A and 25B illustrate examples of size-by-class copper distributions, in accordance with various embodiments of the present disclosure.

FIG. 26 illustrates an example of the effect of contact angles on energy barriers, in accordance with various embodiments of the present disclosure.

FIG. 27 illustrates an example of probabilities for bubble-particle collision, attachment and not being attached, in accordance with various embodiments of the present disclosure.

FIGS. 28A and 28B illustrate examples of the effect of froth height on pulp phase rate and recovery, in accordance with various embodiments of the present disclosure.

FIGS. 29A and 29B illustrate examples of the effect of surface liberation, in accordance with various embodiments of the present disclosure.

FIGS. 30A and 30B illustrate examples of copper recoveries by cell and grade, in accordance with various embodiments of the present disclosure.

FIG. 31 illustrates an example of normalized rate constants for different particle sizes, in accordance with various embodiments of the present disclosure.

FIGS. 32A and 32B illustrate examples of size-by-size recoveries and rate constants, in accordance with various embodiments of the present disclosure.

FIG. 33 is a schematic block diagram of an example of a computing device, in accordance with various embodiments of the present disclosure

### DETAILED DESCRIPTION

Disclosed herein are various examples related to improved flotation throughput for the recovery of particulate materials. A mined ore must be crushed and ground first to detach a desired mineral from the waste rocks co-present in the ore before separating them from each other by using the flotation process. In flotation, surface forces are used to selectively attach hydrophobic particles to the surface of air bubbles. The process becomes inefficient with coarse particles above approximately 150 microns due to the gravitational forces affecting the separation. A mined ore can also be finely ground to detach desired mineral grains from waste rocks prior to separating them from each other by flotation. The flotation process is inefficient when the particle sizes involved are very small, e.g., <10-20 microns. The minerals industry addresses this problem by recirculating part of the waste materials as circulating load to recover misplaced mineral fines by flotation. This approach does not work as well as perceived based on the equal stage recovery assumption.

For coarse particles, a hybrid process is developed in which surface forces can be used to attach small air bubbles to the surface of hydrophobized coarse particles and decrease their effective specific gravities (SGs), thereby allowing them to be separated using a mineral jig, which is designed to separate particles according to the SGs of the mineral particles involved. For fine particles, novel methods are presented of recovering ultrafine mineral particles that can use small oil drops and/or high concentrations of microbubbles. A model-based computer simulator is disclosed that can be used to optimize flotation plants to substantially increase throughput and recovery while minimizing energy consumption. Reference will now be made in detail to the description of the embodiments as illustrated in the drawings, wherein like reference numbers indicate like parts throughout the several views. While the examples are presented in the context of copper-bearing minerals recovery, the methodologies are equally applicable to the recovery of other metal-bearing minerals, e.g., gold, silver, aluminum, etc.

Due to declining ore wades, the cash costs of producing copper have been escalating while its demand is anticipated to grow sharply in the foreseeable future. Much of the cost associated with extracting copper from low-grade ores is born from comminution for mineral liberation, followed by flotation. Despite its longstanding successes, flotation is effective over a relatively narrow particle size range and suffers from low separation efficiencies due to the entrainment of gangue minerals into froth products. For these reasons, much of the ultrafine particles are lost to final tailings, while at the same time, copper-bearing minerals are also lost as part of the coarse particles that are beyond the effective particle size range of flotation.

The effective particle size range of flotation can be expanded with more efficiently recovery for both the ultrafine fine and coarse particles. The former can be addressed by using recyclable oil drops to selectively collect hydrophobic particles without lower particle size limit and the entrainment problem, while the latter can be addressed by using a hybrid flotation concept using both the surface and gravitation forces for coarse particles recovery. An advanced circuit simulator can also be developed that can be used to identify the best possible options to maximize the recovery and throughput by judiciously incorporating the new technologies. The simulator can be based on a flotation model developed from first principles that can predict both recovery and grade on the basis of the size-by-class mineral liberation data obtained for specific flotation feed of interest by using mineral liberation analyzers. When successfully integrated, these three technologies (fine particle recovery, coarse particle recovery, and modeling) can lead to innovative and revolutionary changes in the design of copper recovery processes.

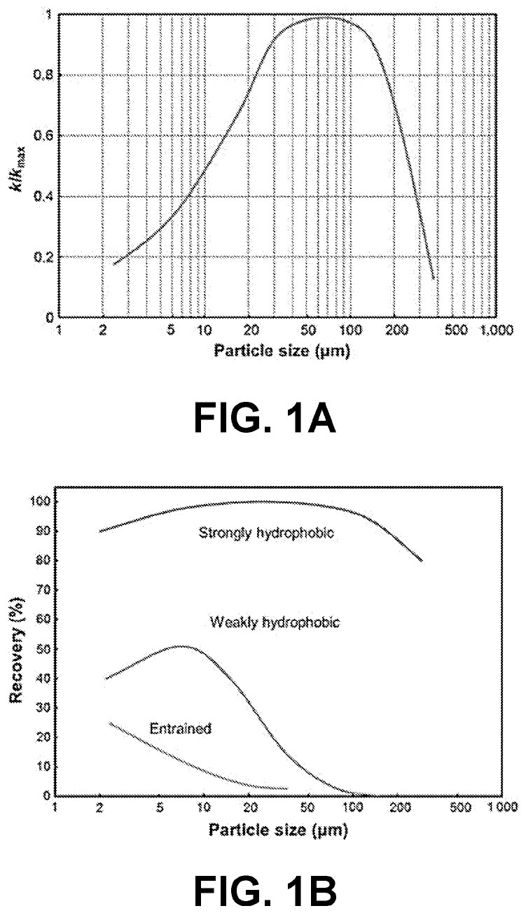

Practically all metals humans use today are being produced by flotation, and it is still the best available method of separating mineral fines. For example, flotation is the primary separation method used to produce copper concentrates for smelting. As is known, however, flotation has two major limitations: i) narrow particle size range typically in the 20-200 μm range, and ii) poor selectivity below 20 μm. FIG. 1A illustrates an example of flotation rate constants (relative to the maxima, k/kₘₐₓ) plotted as a function of particle size. FIG. 1B shows that slow-floating particles (fine and weakly site particles) are recovered by entrainment. In a typical mineral processing plant, flotation and pumping each account for 10% of the total energy consumption, while grinding accounts for about 70% of the total.

For processing low-grade ores, the bulk of the energy is consumed for grinding gangue minerals. Therefore, mill operators have been searching for ways to remove the waste (or ‘dead’) rocks during the rougher-scavenger flotation stage, so that they can reduce the volume of materials that are fed to regrind mills by a factor of 10 or more and thereby save significant energy. For this approach to work, it is necessary to extend the upper particle size limit of flotation, which is a challenge as coarse particles are readily detached from air bubbles in the pulp phase of a mechanically agitated flotation cell. Turbulence is utilized to generate small air bubbles and improve bubble-particle collision particularly for fine particles. For coarse particle flotation, one approach is to feed an ore slurry into a fluidized bed that provides good mixing with minimal turbulence.

The maximum particle size that can be recovered using these methods will depend on the surface areas of the copper-bearing mineral grains exposed on the surface, their local contact angles, and the surface tension. Also, the coarse particles cannot be carried into the froth phase, which makes it difficult to produce high-grade concentrates. Furthermore, the tailing stream may include particles, inside of which copper-bearing mineral grains are encapsulated, that will be difficult to recover. It has been found at a large porphyry copper ore flotation plant that mineral liberation drops dramatically above 150 μm, causing difficulties in floating particles above this size due to the small area of surface exposure for copper-bearing minerals.

Extending the lower particle size limit can also help minimize the energy consumption. In general, the finer the particle, the higher the degree of liberation; therefore, higher grade concentrates can be obtained with ultrafine particles. On the contrary, product grades deteriorate with decreasing particle size due to the problem of hydraulic entrainment as briefly noted in conjunction with the data presented in FIGS. 1A and 1B. Furthermore, fine particles are difficult to be recovered due to the low probability of collision with air bubbles.

The issues concerning fine particle recovery have been articulated as follows: “after addressing liberation with ultrafine grinding in an inert stirred mill, an alarmingly high proportion of <10 μm and particularly <5 μm fully liberated Platinum Group Minerals (PGMs) were being lost to tailings” (“Improved flotation of PGM tailings with a high-shear hydrodynamic cavitation device” by Ross et al., Minerals Engineering, 137, 133-139, 2019). In an earlier publication, “the problem of fine particle flotation is unlikely to be solved by introducing more power into conventional flotation cells, and that different flotation technology would be needed to overcome the problem” (“Flotation cell technology and circuit design-an Anglo Platinum perspective' by Rule and Anyimadu, Journal of the Southern African Institute of Mining and Metallurgy, 107 (10), 615-622, 2007).

The hydrophobic-hydrophilic separation (HHS) process can represent the “different flotation technology” needed to address the problems associated with fine particles recovery. The disclosed technology addresses the two major problems in using the conventional flotation process by extending its lower particle size limit to submicronic particles and by eliminating the hydraulic entrainment problem to maximize the selectivity. The results obtained from laboratory tests conducted on samples of cleaner-scavenger tails (CST) from a porphyry copper ore flotation plant showed that salable concentrates assaying >30% Cu can be obtained, while at the same time making it possible for the plant operators to move away from the traditional closed-circuit configuration to substantially increase the production of copper concentrates with minimal capital expenditure.

### A) Fine Particles Recovery

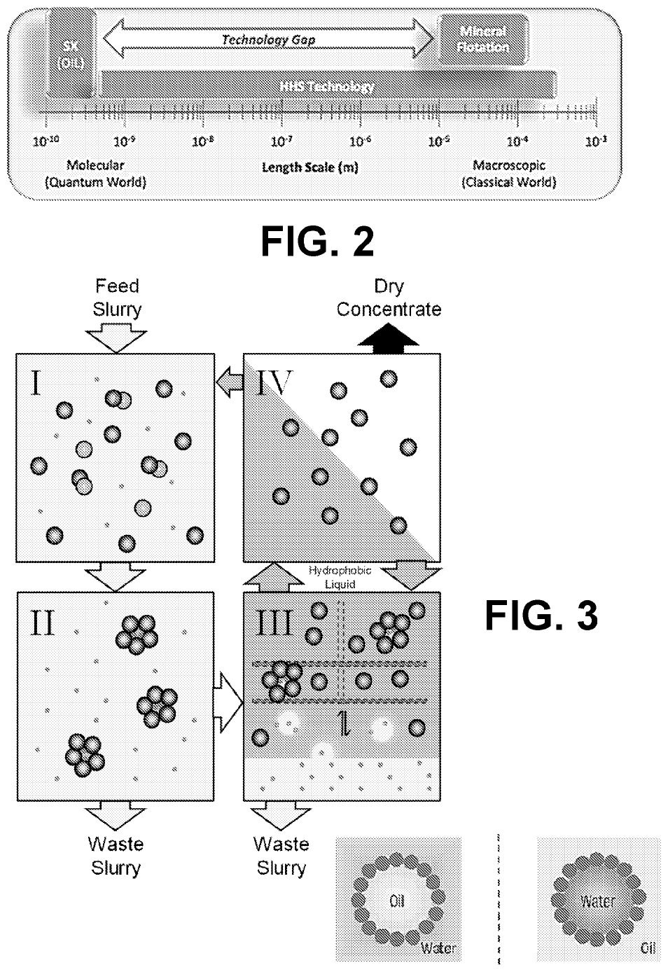

Various methods of recovering very fine particles in mineral processing in general included i) surface-based methods, ii) magnetic and electrostatic methods, and iii) gravity concentration. Of these, the first group has been considered the most promising, simply because surface property gains its importance with decreasing particle size (dₚ) as dₚ⁻², while gravity loses its importance as dₚ⁻³. Magnetic and electrostatic separations behave similarly to gravity separation and the inertia of the particles moving in magnetic and electrostatic fields plays an important role. In these regards, it is not surprising that flotation has been used in the minerals industry as the primary method of separating fine particles. The process is based on selectively attaching hydrophobic particles to the surface of air bubbles, in which surface forces play a decisive role in determining the kinetics of bubble-particle attachment. However, the process becomes inefficient at dₚ<20 μm. FIG. 2 illustrates a comparison of the length scales of solvent extraction (SX), mineral flotation, and HHS technology.

In flotation, a particle collides with an air bubble, causing the latter to deform, which in turn creates a capillary pressure (p) in the wetting film of water, formed between the two macroscopic surfaces. Since p>0, the water in the film drains and the film thins. If the film thins to <250 nm (0.25 μm), the film thinning begins to be controlled by the disjoining pressure (II), which is created by the surfaces forces, e.g., electrical double-layer (EDL), van der Waals (vdW), and hydrophobic (HP) forces. In flotation, both the EDL and vdW forces are repulsive, while the HP force is attractive. Thus, flotation will occur when the attractive HP force becomes stronger than the sum of the EDL and vdW forces, both of which are repulsive.

That the vdW force is repulsive for bubble-particle interactions is a major disadvantage of flotation, in which air bubbles are used to selectively collect hydrophobic particles. If oil drops rather than air bubbles are used to for the same purpose, the vdW force becomes attractive. Therefore, it takes much less energy for oil drops to attach themselves to hydrophobic surfaces and form larger contact angles. The higher the contact angle, the higher the flotation recovery. Therefore, oil drops are superior collectors for hydrophobic particles. Also, the higher the contact angle, the stronger the hydrophobic forces. Therefore, the kinetics of flotation is much faster with oil drops than with air bubbles.

To overcome the difficulty in fine particle recovery, the concept of two-liquid flotation (TLF) was developed during the 1960-70s. In this process, oil droplets rather than air bubbles were used to collect hydrophobic particles from an aqueous phase. Many investigations have shown that oil drops are more efficient for the recovery of ultrafine particles. For example, a process has removed anatase (TiO₂) and iron oxides (Fe₂O₃) from kaolin clay slip (5 μm top-size) using emulsified oil droplets. Quartz particles (−44 μm) were efficiently floated using oil drops rather than air bubbles. Alumina (Al₂O₃) particles (0.1 μm) were recovered using isooctane to recover submicronic particles.

These investigations suggested that the fine particles were recovered as oil-in-water (o/w) emulsions stabilized by surfactant and/or hydrophobic particles. The process variables included particle hydrophobicity as measured by water contact angles (θ) and the ζ-potentials. Thermodynamically, particles with θ>0° can be collected at the oil/water interface in the same manner as air bubbles collect hydrophobic particles. When θ>90° and the ζ=0, however, hydrophobic particles can cross the water/oil interface and be dispersed in oil droplets, causing the droplets to become too heavy to float and hence fall to the aqueous phase by gravity. A variety of organic liquids of varying interfacial tensions, e.g., cyclohexane, toluene, benzene, etc., have been used to recover submicronic (0.18 μm) TiO₂ particles from aqueous phase. More recently, magnetic nanoparticles (0.001 μm) were transferred from an aqueous phase to a second non-miscible non-aqueous phase.

The two-liquid flotation process results have demonstrated that oil and other organic liquid drops are better than air bubbles to collect hydrophobic particles from water, particularly for ultrafine particles. It appears that there is no lower particle size limit, which is not surprising in that the process is similar to solvent extraction, which is designed to selectively transfer metallic ions (e.g., Cu²⁺ or Co²⁺ ions) from an aqueous phase to an organic phase (e.g., kerosene). A prerequisite for the transfer of the ions is the hydrophobization of the ions using a ligand (chelating agent). Thus, both the two-liquid flotation and solvent extraction processes are controlled by the same mechanism, i.e., hydrophobic interaction, spanning over the 5 to 6 decades of length scales, as shown FIG. 2. According to the results of molecular dynamic simulations, hydrophobic interaction is driven by entropy at the molecular scale (<1 nm) and by enthalpy at the macroscopic scale. The latter has been shown experimentally.

Despite the advantages of using oil drops as ‘collector’ for hydrophobic particles, the two-liquid flotation may be difficult to commercialize unless the spent oil is recycled properly. Therefore, the hydrophobic-hydrophilic separation (HHS) process was developed, in which oils with low boiling points and low heats of vaporization, e.g., pentane and heptane. See, e.g., U.S. Pat. No. 9,518,241, which is hereby incorporated by reference in its entirety.

As schematically represented in FIG. 3, a recyclable oil can be added to an ore slurry in Step I to allow the small oil droplets to collide with the fine particles suspended in water and collect the hydrophobic particles on the surface and form an oil-in-water (o/w) emulsion in Step II. The hydrophobic particles act as solid surfactant (or emulsifier) as is the case with stabilizing Pickering emulsions. The hydrophilic particles not collected by the oil droplets are discharged as reject (or tail). The o/w emulsion drops (which might be called agglomerates) move on to a specially-designed device known as Morganizer, in which additional oil is added to induce phase inversion and form a water-in-oil (w/o) emulsion in Step III.

The inset of FIG. 3 illustrates that the phase inversion can be induced by simply increasing the phase volume (ϕ) of oil. The w/o emulsion formed in this manner is subsequently destabilized by applying an appropriate mechanical force to liberate the hydrophobic particles from the water droplets and be dispersed in the continuous oil phase, while the water droplets coalesce with each other and become larger and settle to the bottom and be discharged. When the drops are removed in this manner, hydrophilic particles dispersed in them are also removed, which is the basis for eliminating hydraulic emulsion and thereby producing high-grade concentrates. Thus, the hydrophobic particles dispersed in the oil phase are then separated from the organic matter by solid-liquid separation and vaporization to obtain a high-grade concentrate in Step IV, with the spent oil being recycled.

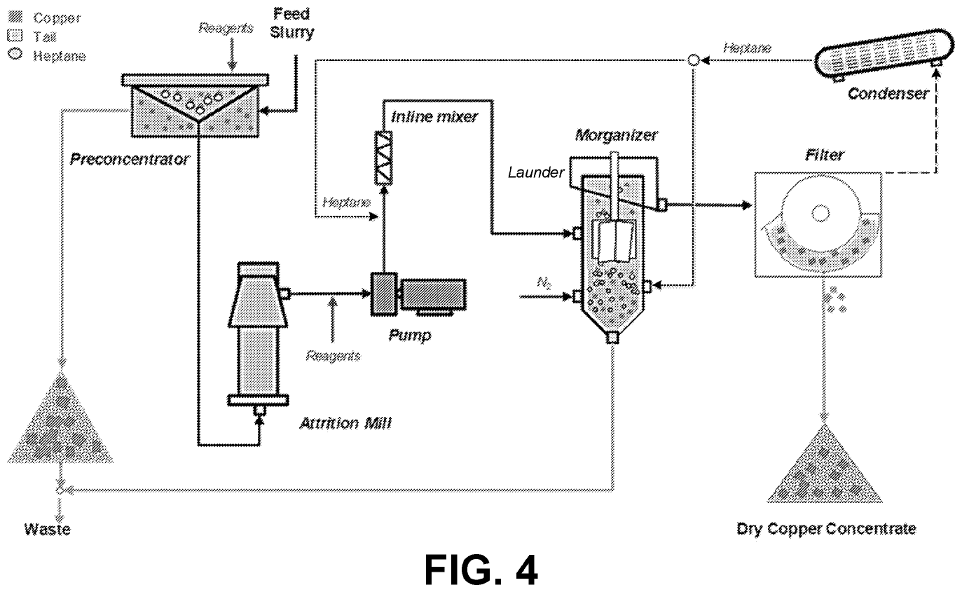

Proposed Flowsheet. FIG. 4 illustrates an example of the HHS process that may be used for the recovery of copper-bearing minerals (e.g., chalcopyrite) from a cleaner-scavenger tail (CST). The copper mineral particles present in a CST represent the slow-floating particles due to their small particle size, incomplete liberation, and/or superficial oxidation. It is believed that a substantial portion of the chalcopyrite is in the form of composite particles in the −20 μm fraction. Therefore, to improve the liberation, attrition milling may be performed before subjecting the material to the HHS or TLF process. To reduce the volume of the materials going through the mill and subsequent steps, the CST may be subjected to flotation to obtain a preconcentrate assaying 2-4% Cu from a feed grade of about 0.2% Cu. If the copper recovery is 90%, only 10% of the materials present in the CST will be processed by the HHS process to obtain a salable product.

As shown in FIG. 4, the feed slurry is fed to a flotation cell (preconcentrator) to obtain a preconcentrate, which is milled by an attrition mill and subjected to the HHS process. Reagents can be added to the mill product before being pumped to an inline mixer. The mill product is contacted with oil (e.g., heptane, hexane, iso-hexane, etc.) in an inline mixer to recover hydrophobic copper mineral particles as an o/w emulsion (or an agglomerate), which can then be converted to a w/o emulsion in the Morganizer. In the TLF process, less energy is added to the pump-inline mixer assembly to form loose oil-copper aggregates rather than well-defined agglomerates. It takes less energy to form aggregates than to form tightly-held agglomerates. Furthermore, the former can be dispersed more readily in the Morganizer. The emulsion is mechanically destabilized to remove water along with entrained gangue minerals. The spent oil is recovered by a filter, which can be equipped with a steam stripper (or heated N₂), and sent to a condenser, where it can be recycled in the HHS process.

In the HHS or TLF process, the mill discharge is contacted with a hydrophobic liquid, e.g., iso-hexane, to recover the copper-bearing minerals in a circuit comprising a centrifugal pump and the inline mixer in the same manner as with a Microcel flotation column. The oil-particle aggregates (o/w emulsion) formed in this arrangement are fed to a Morganizer, in which the aggregates are broken up by means a specially designed impeller, so that the hydrophobic copper minerals are dispersed in the hydrophobic liquid (oil) while the entrained water is removed along with the hydrophilic gangue mineral particles dispersed in it. The copper minerals dispersed in the organic phase overflows into a launder, while the gangue minerals dispersed in the entrained water are discharged from the bottom of the Morganizer. Although the impeller is designed to create an upward flow of oil, it may be necessary to inject nitrogen (N₂) to prevent the copper minerals from falling to the aqueous phase at the bottom. The impeller is designed to provide sufficient energy to break the agglomerates or aggregates. If too much energy is used, a stable w/o emulsion is formed, which is counterproductive. It is also necessary to provide a sufficient surface area on which the water drops liberated from the breakage of w/o emulsion droplets or agglomerates coalesce with each other and form large water drops that can fall out of the organic phase. A jig with hydrophilic ragging materials may be used for this purpose as described in U.S. Pat. No. 10,561,964 (“Apparatus for Dewatering and Demineralization of Fine Particles” by Yoon et al.), which is hereby incorporated by reference in its entirety.

The copper-bearing minerals gathered by the launder can be separated from the oil by filtration. The residual amount of oil adhering to the surface can be separated by vaporization and condensation. The copper concentrate that is discharged from the filter is usually dry and relatively free of gangue minerals. The amount of the residual oil left can be less than 100 ppm.

Laboratory Test Results. A series of HHS tests were conducted on a CST sample taken from a porphyry copper ore flotation plant, and the results were compared with those of flotation tests. Table 1 shows the results of the flotation tests conducted on a sample with and without grinding in a ball mill. The test conducted on the as-received sample with d₈₀=75 μm produced a concentrate assaying 0.87% Cu with a 77.1% copper recovery, while the ball mill ground sample produced a 1.11% Cu concentrate with a 84.3% recovery. The improvement in both the recovery and grade due to grinding may be attributed to the improved liberation, suggesting that the copper-bearing particles present in a CST are due to the small particle size, incomplete liberation, and/or superficial oxidation.

TABLE 1
Results of the Flotation Tests Conducted on a
CST Sample with and without Grinding

| d₈₀ | | Weight | Grade | Distribution (%) | |
|---|---|---|---|---|---|
| (μm) | Products | % | % Cu | Ind. | Cum. |
| 75 | Conc. | 16.2 | 0.87 | 77.1 | 77.1 |
| | Tail | 83.8 | 0.05 | 22.9 | 100.0 |
| | Feed | 100.0 | 0.183 | 100.0 | — |
| 14 | Conc. | 14.5 | 1.11 | 84.3 | 84.3 |
| | Tail | 85.5 | 0.04 | 15.7 | 100.0 |
| | Feed | 100.0 | 0.191 | 100.0 | |

Table 2 shows the results of the HHS tests conducted on the same samples. The product grade obtained with the as-received sample was higher than obtained by flotation; however, the recovery was substantially lower. The main reason was that the volume of oil that was used to recover the copper mineral particles was far less than the volume of the air used for the flotation tests. In the latter, the air volume was practically unlimited which was responsible for the higher recoveries. The low recovery problem will be mitigated in a continuous HHS test. In this regard, the amount of oil was increased in the next HHS test conducted on the ground sample with d₈₀=14 μm. Indeed, the copper recovery was increased to 75.8% with a grade of 34.7% Cu which was close to the theoretical maximum of 34.8% Cu.

TABLE 2
Results of the HHS Tests Conducted on a
CST Sample with and without Grinding

| d₈₀ | | Weight | Grade | Distribution (%) | |
|---|---|---|---|---|---|
| (μm) | Products | % | % Cu | Ind. | Cum. |
| 75 | Conc. | 2.5 | 2.96 | 41.1 | 41.1 |
| | Tail | 97.5 | 0.11 | 58.9 | 100.0 |
| | Feed | 100.0 | 0.182 | 100.0 | — |
| 14 | Conc. | 0.5 | 34.69 | 75.8 | 75.8 |
| | Tail | 99.5 | 0.06 | 24.2 | 100.0 |
| | Feed | 100.0 | 0.247 | 100.0 | — |

The results presented in Tables 1 and 2 show that the HHS process can be substantially more selective than flotation, which can be attributed to the elimination of the hydraulic entrainment by removing the entrained water in the Morganizer. The HHS process can also give recoveries higher than flotation in continuous operation. Indeed, a series of continuous HHS tests conducted on artificial mixtures of chalcopyrite and silica samples with d₈₀=10 μm showed that copper concentrates assaying 29-30% Cu were obtained with 92-93% copper recovery.

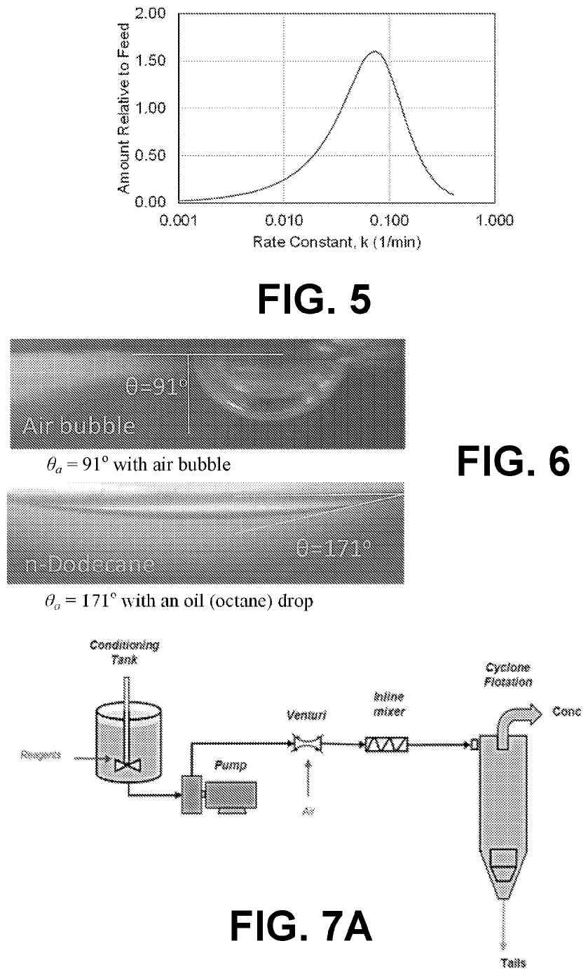

Benefits of Using HHS Process. Most of the copper producers in the US are running closed flotation circuits, in which cleaner scavenger tails (CSTs) are recirculated to the rougher-scavenger flotation banks. Circuit simulations show that building up circulating loads should help increase the separation efficiencies (SEs) of the circuits as a whole. The magnitude of the impact, however, is exaggerated as the analyses implicitly assumed that the recycled materials have the same recoverability as the fresh feeds coming to the circuits. In this regard, circuit simulations were conducted using distributed rate constants (kᵢⱼ), which are functions of particle size (i) and liberation class (j), ranging from 0.001 to 1.0 min⁻¹. The simulations were conducted at retention times of 2.5 min for each of the rougher and scavenger cells and 4 min recleaner cells, with a feed ore assaying 0.74% Cu. The results show that slow-floating materials with kᵢⱼ=0.08-0.09 min⁻¹ significantly build up in the rougher-scavenger bank, with 1.5 tons of recycled material for each ton of fresh feed. FIG. 5 illustrates an example of closed-circuit flotation with CST returning to the rougher-scavenger bank show a build-up of slow-floating materials. The slow-floating particles accumulating in the rougher-scavenger banks are roughly 5 to 35% liberated and are of 5 to 12 μm in size. These are characteristic of those found in typical CSTs.

There are two ways of solving the problem and increasing plant throughput: i) discard the slow-floating materials to the tailings pond and increase the throughput with fast-floating fresh feeds, or ii) do the same while recovering the valuable copper-bearing minerals from the CST streams using an alternative process such as HHS, TLF, or cloud flotation process. The two options have been simulated, and the results are presented in Table 3. Also shown is the baseline case of using a closed-circuit configuration without an HHS process. Under this condition, the hypothetical copper flotation plant will produce 160 million pounds of copper per annum at a closed-circuit configuration. The simulations were carried out under typical operating conditions using realistic rate constants, pulp densities, and retention times. To fully evaluate the deportment of all particle classes, kᵢⱼ values of 10 different particle sizes and 4 different liberation classes were considered.

TABLE 3
Summarized Simulation Results

| | Copper Production (10⁶ lb/yr) | | |
|---|---|---|---|
| Options | Closed | Open | Open/HHS |
| Fixed Feed Rate¹ | 160 | 148 | 163 |
| Low CST Flow² | 160 | 174 | 191 |
| High CST Flow² | 160 | 200 | 219 |

¹Grinding mill limited,
²Rghr-scvgr cell limited

The simulation results summarized in Table 3 have been obtained by considering three cases. In the first case, the throughput was limited by the grinding circuit capacity, in which case the feed rate to the flotation circuit was fixed. In the second and third cases, the throughput was limited by the retention time in the rougher-scavenger banks, which in turn allowed the feed rate to the flotation circuit to be increased until the rougher-scavenger retention time matched that of the baseline case, i.e., the closed-circuit case. In the second case, it was assumed that the volumetric flow of the CST was assumed to be 15% of the feed to the rougher-scavenger bank, while in the third case the CST flow was assumed to be 25% of the total feed rate.

Overall, these simulations suggest that the plant's copper production can be significantly increased by opening the circuit and adding an HHS unit to treat the CST. In all the scenarios tested, the HHS circuit was continually shown to produce the highest overall copper production and the highest overall copper grade. In the most optimistic case (high CST flow), the HHS circuit was shown to have a total annual copper production of nearly 219 million lb./year, a value 38% higher than that of the closed circuit and nearly 10% higher than that of the open circuit. Moreover, even in the case where the flotation feed rate was fixed, opening the circuit and adding the HHS unit imparted a significant increase in the overall annual copper production. As expected, the simple open circuit was not found to be effective unless the flotation feed can be significantly increased.

Reagent. The higher the contact angle, the easier it is to float a mineral. FIG. 6 shows that an oil drop gives nearly twice as large a contact angle (θₒ) as an air bubble (θₐ) on a hydrophobic surface. This provides a thermodynamic explanation of why HHS is so much superior to flotation. In the HHS process, the oil contact angles of the copper-bearing minerals (θₒ) can be increased above 90°, which is not difficult to achieve. Use of a more powerful hydrophobizing agent may float composite particles without full liberation or finer grinding. Also, some of the copper-bearing minerals may be oxide copper that may require the use of reagents other than the conventional thiol collectors, e.g., xanthate or thionocarbamate.

### B) Cloud Flotation

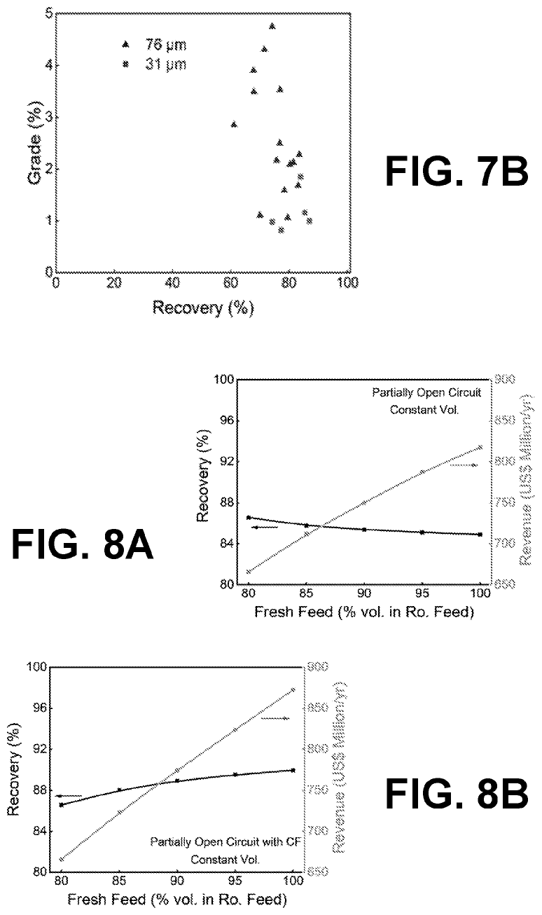

Fine particles are difficult to recover due to their low inertia which reduces their probability of bubble-particle attachment (Pₐ). Also, it is necessary to increase the collision probability by increasing the number of air bubbles in a flotation cell. To meet these requirements, a new fast flotation process, known as Cloud Flotation (CF) has been developed. In this process, an aqueous slurry of fine particles, e.g., CST flow, is injected into a highly turbulent force field created in an inline mixer, so that bubble-particle interactions occur with a high collision efficiency to maximize Pₐ. The inline mixer generated microbubbles in high number densities, which should increase the rate of flotation kinetics as will be shown in the modeling section of this disclosure. The bubble-particle aggregates formed in the inline mixer or in a separate mixing tank are then injected into a cyclonic flotation system, which can comprise a specially designed cyclonic separator, in which these lighter bubble-particle aggregates are collected as a concentrate through the vortex finder, while the heavier gangue minerals are rejected through the apex. FIG. 7A shows the process schematics, with a set of preliminary test results obtained with artificial copper ore feeds with feed assays of 0.3% Cu and particle sizes of d₈₀=31 and 76 μm presented in FIG. 7B. The maximum concentrate grade achieved to date was 5.1% Cu with a recovery of 77% with a retention time of less than 1 s. These results may support the concept of using a fast flotation process to recover the copper values present in a CST flow to maximize throughput at a minimal copper loss. Table 4 shows the comparison between cloud flotation and Denver cell test run with artificial copper samples. It can be seen that the cloud flotation cell can achieve high recoveries in less than 1 second (0.015 min).

TABLE 4

| Denver Cell | | | Cloud Flotation Cell | | |
|---|---|---|---|---|---|
| Time (min) | Recovery | Grade | Time (min) | Recovery | Grade |
| 0 | 100.0 | 0.54 | 0.015 | 77.2 | 5.05 |
| 2 | 91.1 | 8.33 | | | |
| 1 | 75.4 | 10.32 | | | |
| 0.5 | 58.0 | 13.95 | | | |

Closed vs. Open Circuit Simulations. Recognizing that the copper-bearing minerals present in the circulating load (or CST) represent slow-floating fine particles which are hard to recover, it may be financially beneficial to open the rougher flotation circuit so that all or part of the CST that is recirculated is replaced by the fresh feed. In this regard, a series of simulations were run using the flotation model at a constant volumetric flow rate by replacing CST incrementally, with the results presented in FIG. 8A. In a closed-circuit configuration, the CST account for 20% and 11.6% of the volumetric and mass flow rates of the throughput of the rougher flotation circuit, respectively. If the entire CST flow is replaced by fresh feed, the overall plant revenue was increased by about 23% but at a loss of copper recovery by about 2% as shown in FIG. 8A. If all or part of the CST that is displaced by fresh feed is processed in a separate recovery system, e.g., cloud flotation, to recover 75% of the copper values in the CST, one can readily increase both the revenue and the copper recovery as shown in FIG. 8B. It is not necessary to produce high-grade copper concentrates from the CST flow not being recirculated. One can also use the HHS or TLF process to realize the significant financial benefits.

### C) Coarse Particle Flotation

Flotation is regarded as the best-available separation process for the recovery of fine particles. A mined ore is ground typically to less than 100 μm to liberate the valuable mineral, e.g., copper sulfide (CuFeS₂), from the gangue minerals, e.g., quartz (SiO₂), with the fine particles dispersed in an aqueous (or pulp) phase. A hydrophobizing agent (collector) can be added to the pulp phase to selectively render the valuable mineral hydrophobic. Air bubbles can then be introduced to the pulp to collect the hydrophobized particles on the surface, leaving the hydrophilic ones unattached. The bubble-particle aggregates formed in this manner rise in the pulp phase due to increased buoyancy, form a froth phase on top of the pulp phase, and flow into the launder to be recovered as a concentrate, while the hydrophilic particles leave the cell as tailings.

As the grade of copper ore declines, it becomes necessary to grind the ore finer, causing the cost of recovering copper-bearing minerals by flotation due mainly to the high cost of grinding. A recent study showed that the cost of grinding accounts for about 70% of the total. One way to minimize the cost would be to float copper minerals at coarse particle sizes to avoid fine grinding. It has been shown, however, that the liberation of copper minerals drops sharply at particle sizes above about 150 μm, which in turn makes it difficult to produce high-grade copper concentrates. In addition, coarse particles are difficult to be recovered using the mechanically agitated conventional flotation machines due to the combined effect of the high degree of turbulence and poor liberation. Only a small portion of the surface area of a poorly liberated particle is hydrophobic; therefore, it can be readily detached from air bubbles in a turbulent flow field.

Many coarse particle flotation cells have been developed, in which bubbles and particles collide with each other in a fluidized bed to reduce turbulence and hence minimize the probability of particles being detached from air bubbles. The Hydrofloat cell used a combination of air bubbles and upward fluidization water injected at the bottom of a flotation cell to assist coarse particles to move upward. The cell is designed to operate on de-slimed feeds without the froth phase. The Nova Cell used a fluidized to provide low-energy bubble-particle contacts. The cell operated was designed to process by-zero feeds (i.e., without desliming), so that fine particles are recovered through the froth phase, while coarse particles dropped off at the pulp-froth interface and were recovered as a separate product stream. Both of these coarse particle flotation methods did not take advantage of the cleaning actions of the froth phase, which may be a significant disadvantage in producing high-grade products.

A method using the Reflux Flotation Cell (RFC) for coarse particle recovery has been disclosed. In this method, an ore slurry is fed to a highly-turbulent mixing device, known as a downcomer, in which air bubbles selectively collect hydrophobic particles. The discharge from the downcomer flows through channels created between a set of inclined plates. The air bubbles laden with hydrophobic particles rise and form a thin layer of froth phase along the upper walls of the inclined plates, while the pulp phase in which hydrophilic particles are dispersed flow downward along the lower walls of the inclined plates. The distance an air bubble travels to form a froth layer in an inclined channel is much shorter than in a conventional flotation cell, which may facilitate the segregation rate of the bubbles due to the Boycott effect. In effect, the RFC process operates with multiples of inclined froth phases. The system can provide quiescent flow conditions, which appears to facilitate coarse particle flotation. The separator can work well at gas fluxes (otherwise known as superficial gas rate (or J_{g}) below 0.5 cm/s. It is possible that the flow conditions become turbulent at higher gas fluxes. Considering that the superficial gas rates are usually in the range of 2.0 cm/s in conventional flotation cells, the RFC system may have a limitation in throughput.

A jig is a separation device used to separate different minerals according to their specific gravities (SGs). This is accomplished by moving the fluid, in which the mineral particles are suspended, up and down repeatedly until the mineral particles form two layers—lower SG minerals forming a layer on top of the layer of the higher SGs. A hybrid jig, in which air bubbles are introduced so that they adsorb to polyvinyl chloride (PVC) but not to polyethylene (PE), was developed so that the former forms a layer on top of the other. Without the use of air bubbles, separation between PVC and PE is not possible because both have the same SG values of 1.31. A jig provides an advantage in that it can separate particles that are orders of magnitudes larger than those used in flotation. Despite the use of air bubbles, the hybrid jig is still a gravity separation process in the sense that the number of air bubbles used is much smaller than those used in flotation. Therefore, no froth phase is formed on top of the pulp phase. In flotation, froth phase plays an important role in increasing product grades.

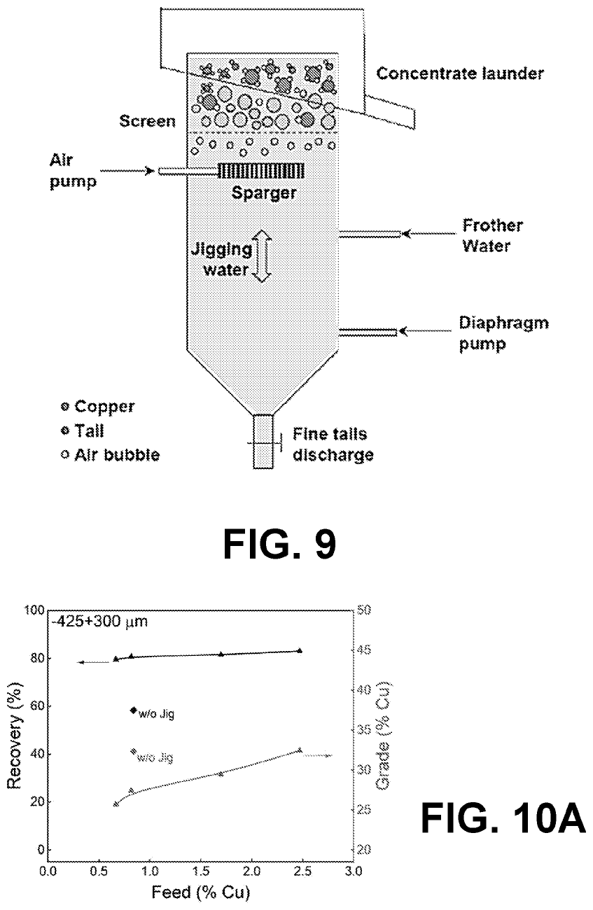

A hybrid jig has been modified to develop a Jig Flotation process, in which a sufficient number of air bubbles is used to form a froth phase in the upper part of the cell. FIG. 9 is a schematic representation of a laboratory-scale Jig Flotation cell. The water in the column moves up and down by means of a diaphragm pump to stratify the coarse particles in the upper chamber of the cell to stratify according to their specific gravities (SGs). Air bubbles are produced in the cell to allow them to attach to the copper-bearing mineral particles that have been selectively hydrophobized using potassium amyl xanthate (KAX) so that their effective SGs become lower than the silicious gangue mineral particles. During the pulsion stroke of the jigging cycle, bubble-particle aggregates are subjected to strong acceleration velocities that allow the coarse particles to cross the pulp-froth interface, and be subjected to the froth cleaning mechanism. The copper minerals float into the launder to be recovered as a concentrate, while the silicious gangue minerals are discharged through the bottom as tailings.

### Example 1

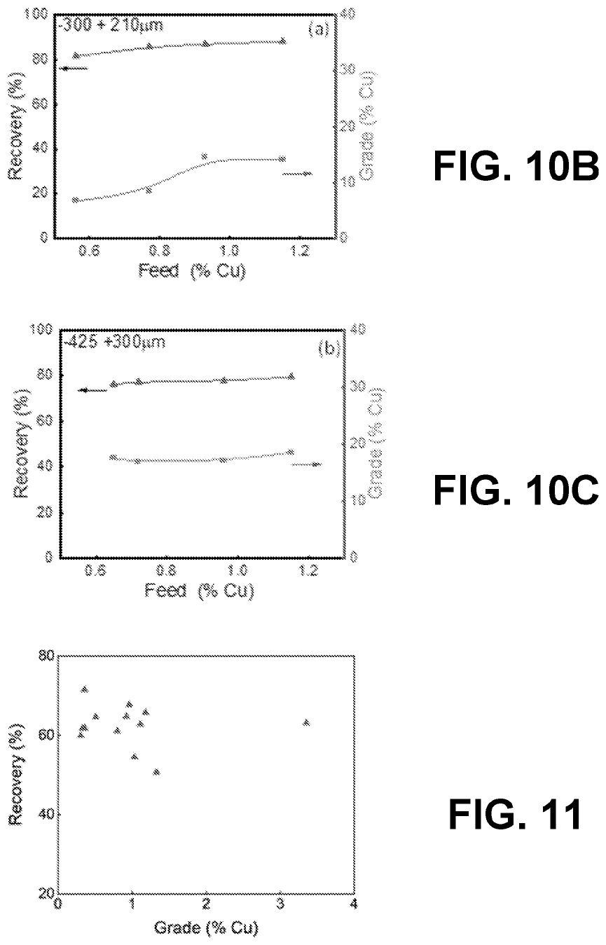

Artificial feed samples containing pure chalcopyrite and silica gel were used for coarse particle flotation with 1-inch diameter jig flotation unit as illustrated in FIG. 9. A 200-mesh screen was placed 2 inches below the launder. Pure chalcopyrite samples were crushed and screened to a particle size of 300-425 μm. Tests were conducted with and without jigging motion to analyze the advantages of jig flotation over conventional column flotation cell. During these experiments, 10 g of artificial feed (10% solids) was conditioned with 1 kg/t of PAX as collector and 2 kg/t of methyl iso-butyl carbinol (MI BC) as frother for 5 minutes and 2 minutes, respectively. FIG. 10A illustrates an example of the results obtained with 300-425 μm size fractions.

The jig flotation tests with various feed grades ranging from 0.6%-2.45% Cu were run with a retention time of 2 minutes with the jigging amplitude of 8 gph and frequency of 150 min⁻¹. The flotation tests were run with a feed grade of 0.8% Cu to compare the benefits of jig flotation. The air was injected using a peristaltic pump where the flowrate was kept constant at 2.1 scfh (J_{g}=3.3 cm/s) while the stroke frequency rate for these tests were fixed at 200 min⁻¹. A small amount of make-up water was added to maintain the froth depth. These tests were run with a shallow froth depth of 0.5 in. The flotation test without any jigging action was run with a feed grade of 0.8% Cu to compare the benefits of jig flotation. The recoveries achieved by the jig flotation were substantially higher when compared to conventional column flotation cell illustrating the advantage of upward particle acceleration and fluidization during the pulsation stage of jig flotation. The concentrate grades were slightly lower for the jig flotation as jig flotation process was able to recover the less liberated particles. The recoveries of the jig flotation cell are independent of the feed copper grade showing that this process can be used for low copper grade ores too.

### Example 2

Pure chalcopyrite and quartz samples were crushed and screened to the particle sizes of 210-300 μm and 300-425 μm and run as artificial copper feed samples with different feed copper grades. 5 g of artificial feed (10% solids) was conditioned with 1 kg/T of PAX as collector and 2 kg/T of MI BC as frother for 5 minutes and 2 minutes, respectively. These tests were conducted with varying feed grade ranging from 0.5%-1.2% Cu at a constant jigging amplitude of 8 gph and frequency of 150 min−1. The retention time for each test was 2 minutes. The air flowrate was kept constant at 2.1 scfh and a J_{g} of 3.3 cm/s. A small amount of make-up water was added manually to maintain the froth depth. These tests were run with a shallow froth depth of 1-2 cm to improve the final concentrate grade. FIGS. 10B and 10C illustrate examples of the results obtained with 210-300 μm and 300-425 μm size fractions.

FIG. 10B shows the effects of artificial feed grade on Jig Flotation recovery and concentrate grade with 210-300 μm particles and FIG. 10C shows the effects with 300-425 μm particles. The tests were run with PAX dosage: 1 kg/T, MI BC dosage: 2 kg/T, frother water flowrate: 20 mL/min, air flowrate: 1 lpm, pump amps: 40%, and frequency: 150 Hz and a retention time: 2 minutes. The recoveries achieved by the jig flotation were high for both the size fractions. The recoveries of the jig flotation cell can be said to be independent of the feed copper grade and particle size showing that this process can be used for a wide range of particle size and copper grade ores.

### Example 3

Copper ore samples were obtained from a porphyry copper ore flotation plant and screened to a particle size of 200-600 μm. 6 g of feed (10% solids) was conditioned at a pH of 10.8−11 with 100 g/T of PAX as a primary hydrophobizing agent for 5 minutes and 100 g/T of a hydrophobic polymer poly (2-ethyl hexyl) methacrylate (PX-1) blended with kerosene at a weight ratio of 1:2 as a secondary collector with a conditioning time of 5 minutes. The feed was then conditioned with 200 ppm PPG-425 as a frother for 2 minutes. The conditioned sample was then transferred to the feed screen of 1 inch jig flotation column and the test was run with a thin layer of froth (1-2 cm) for 2 minutes. The jigging amplitude and frequency were kept at 12 gph and 25 min⁻¹ with an air flowrate of 0.64 scfh (Jg=1 cm/s). Make-up water was added to maintain the slurry level in the cell.

Conventional Denver cell flotation tests were also run with the coarse copper ore samples (200-600 μm) to compare with the performance of jig flotation cell. 210 g of feed was used and conditioned with the same collectors and frother concentrations in a 1 L Denver cell. The cell agitation was kept low at 750 rpm with an air flowrate of 1.7 scfh to reduce the turbulence and with a shallow froth depth of 1-2 cm. These measures were taken to improve the coarse particle recovery in a conventional flotation cell. The concentrate was collected until the froth appeared to be devoid of particles.

Table 5 shows the comparison of the performance of conventional flotation and jig flotation cell. Jig flotation cell can achieve higher recoveries and grades with the real copper ore samples due to the reduction in the turbulence in the pulp phase and improved cleaning in the froth phase. The reduction in the turbulence leads to a reduction in the probability of bubble-particle detachment and hence the recoveries increase. As the pulsion stage of jigging motion provides an initial particle acceleration, it helps in overcoming the interfacial tension barrier at the pulp-froth interface and thereby, takes advantage of cleaning action of froth phase.

TABLE 5
Comparison of the results between
Denver cell and Jig flotation cell.

| | PAX | PX-1 | PPG-425 | Feed | Cons | Recovery |
|---|---|---|---|---|---|---|
| | g/T | g/T | ppm | % Cu | % Cu | % Cu |
| Denver Cell | 100 | 100 | 200 | 0.11 | 3.14 | 52.6 |
| Jig Flotation | 100 | 100 | 200 | 0.17 | 3.35 | 63.1 |

More tests were run with low copper grade ore with a feed grade of 0.08-0.18% by varying various Jig Flotation cell operating parameters. The feed for these tests was conditioned with either PAX or PAX and PX-1 and PPG-425 was used as the frother. If PAX was the only hydrophobizing agent used during the test, concentration of PAX was no greater than 1 kg/T. If PX-1 was also used as secondary collector, then the concentration of PAX and PX-1 used was no greater than 100 g/T each. The concentration of PPG-425 used remained constant during the series of test and was 200 ppm. The grade recovery curve for these tests is shown in FIG. 11. Note that the Cu recovery achieved by Denver cell using the same copper feed conditioned with primary and secondary collector was 52.6%. Jig flotation can achieve more than 60% Cu recoveries with such a low copper grade ore. The fluidization and the initial acceleration induced during the pulsion stage of the jigging process helps in achieving near Newtonian flow regime thus helping the bubble-particle aggregates to enter the froth phase without dropping back to the pulp phase.

### D) Modeling and Simulation

Froth flotation is widely used to produce mineral concentrates from ores ground finely for liberation. In the pulp phase of a flotation cell, air bubbles selectively collect hydrophobic particles on the surface. The bubbles laden with the hydrophobic particles rise, enter the froth phase and exit the cell from the top as concentrate, while the hydrophilic particles not collected by the bubbles are discharged through the tailings port at the bottom. In the froth phase, less hydrophobic particles are detached from bubbles and drop back into the pulp phase, providing a built-in recycling and cleaning mechanisms by which separation efficiencies are increased.

Flotation is a difficult process to model from first principles as there are many species that affect both extensive and intensive variables, which control the interactions between the three phases, i.e., solid, water, and air bubbles, involved. The process variables may be subdivided into two groups: hydrodynamic parameters (e.g., bubble size, particle size, energy dissipation rate, etc.) and chemistry parameters (e.g., contact angle (θ), surface tension, ζ-potential, etc.). Many investigators developed flotation models using the former but not much the latter, while flotation separation relies primarily on controlling the chemistry parameters, particularly the contact angles of the particles to be separated from each other. In effect, flotation is a hydrophobic-hydrophilic separation process. The higher the contact angle, the higher the flotation kinetics and hence the recovery. Therefore, the contact angle θ is included as a parameter to develop a model that can predict both recovery and grade. It is a challenge, however, to use θ directly in developing a kinetics model as it is a thermodynamic parameter.

A flotation model has been developed from first principles by considering flotation as a heterocoagulation process, the kinetics of which is controlled by the surface forces in the thin liquid films (TLFs) of water (or wetting films), formed during the last stages of bubble-particle interactions. Bubble-particle interactions are controlled initially by the capillary force, which varies with local curvature changes. As the TLF between the two macroscopic surfaces thins to less than about 250 nm, the capillary force becomes negligibly small as the film becomes more or less flat and the kinetics of film thinning begins to be controlled by the disjoining pressure (Π). If Π<0, the film will rupture to form a finite contact angle at the three-phase contact line. If Π>0, the film will not rupture regardless of the magnitudes of the hydrodynamic forces available for bubble-particle interaction.

Three different surface forces, in the wetting film, often called ‘flotation film,’ which included the electrical double-layer (EDL), van der Waals (vdW), and structural(S) forces, are considered. The structural force, which was related to the surface hydrophilicity, was assumed to become zero when the particle becomes hydrophobic. Under these conditions, bubble-particle attachment should occur as Π becomes negative by virtue of the attractive vdW force becoming stronger than the repulsive EDL force. As is known, however, the vdW force is repulsive in flotation regardless of whether a mineral surface is hydrophobic or not. In this regard, it has been suggested that an attractive surface force not included in the classical DLVO theory needs to be considered to explain the bubble-particle attachment step in flotation. Evidence of the attractive hydrophobic force playing a role in flotation was first presented by showing that a wetting film formed on a methylated silica surface ruptured when the repulsive EDL force was suppressed in the presence of an electrolyte (8.6×10⁻³ mol/L KCI) so that the attractive hydrophobic force became dominant. Direct measurement of the hydrophobic forces in the TLFs of water confined between two curved mica surfaces in the presence of a cationic surfactant using the surface force apparatus (SFA) was later reported. A method of measuring hydrophobic forces between mineral surfaces coated with collectors has been developed using a modified atomic force microscope (AFM).

It has been shown that the hydrophobic forces measured between two surfaces 1 in water 3 can be expressed by a power law,

$$\frac{{F}_{h}}{R} = - \frac{{K}_{131}}{6 {h}^{2}} \qquad [ 1 ]$$

in which Fₕ is the hydrophobic force, R the radius of surfaces, h the closest separation distance between them, and K₁₃₁ is a constant. A relationship between θ and K₁₃₁ has been reported on the basis of direct force measurements conducted between hydrophobic surfaces of varying contact angles using AFM. A similar relationship has also been reported for the exponential force law used in Eq. [11]. A θ vs. K₁₃₁ relationship makes it possible to use K₁₃₁ as a kinetic parameter representing the role of contact angle in flotation. This approach is similar to using EDL and vdW forces to predict the kinetic stability of colloids using the classical DLVO theory. Colloidal suspensions are thermodynamically unstable but can acquire kinetic stability by control of surface forces. Wetting films (called sometimes flotation films) are also thermodynamically unstable. In minerals flotation, the instability of wetting films is promoted by increasing the hydrophobic force via collector coating and/or decreasing EDL forces. In dissolved air flotation (DAF), negative disjoining pressures are created mainly by the control of EDL forces to meet the flotation criterion of Π<0.

In the flotation model developed earlier, the contact angles of the particles present in a flotation feed were calculated from the size-by-class liberation matrix (mᵢⱼ) obtained using the Mineral Liberation Analyzer (MLA) by assuming that fully-liberated galena particles have θ=70° and that fully-liberated silica particles have θ=5°. The results were used to determine the hydrophobic forces from the θ vs. K relationship noted above and subsequently obtained the size-by-class flotation rate constant matrix (kᵢⱼ) for the bubble-particle interactions in the pulp phase. The rate constants calculated in this manner were then combined with those obtained from the froth recovery model to obtain the overall flotation rate constants for the mineral particles of different sizes and degrees of liberation. However, the froth phase recoveries were obtained using a foam stability model to account for the less hydrophobic particles dropping off the bubble surface due to the decrease in the surface area associated with bubble coarsening. It would have been better to use a froth stability model, as the particles in a froth phase greatly affect the stability and hence bubble coarsening.

A froth stability model has been developed by considering the role of particles in the kinetics of film thinning and rupture. The local capillary pressures due to the curvatures of the menisci formed around the particles in lamella films were calculated as functions of contact angle, particle size, and particle loading. The model is able to predict froth stabilities or bubble coarsening due to coalescence as a function of various parameters employed in flotation, e.g., surface tension, froth height, superficial velocity of air, etc. The basic premise of the model is that bubble coarsening provides a mechanism, by which less hydrophobic particles drop back to the pulp phase and are given another opportunity to be recovered in the pulp phase and subsequently in the froth phase. The froth phase recoveries predicted in this manner are in reasonable agreement with those measured using the bubble loading method but are substantially lower than those obtained using the changing froth depth (CFD) method.

Here, a flotation simulator has been developed using the Microsoft Excel VBA platform by incorporating the bubble-coarsening froth model into a pulp-phase flotation model. The simulation results are compared with the results of a continuous flotation test conducted on a copper ore. It will be shown that the simulator can predict grade vs. recovery curves on the basis of feed characteristics (e.g., liberation data), flotation reagent (e.g., collector and frother types and dosages), cell characteristics (e.g., energy dissipation rate that determines bubble size), operating conditions (e.g., feed rate, froth height), and circuit configurations, which can then be used to control the process operations.

### Model

Pulp phase recovery. Flotation begins with collision between bubbles and particles in the pulp phase of a flotation cell. Therefore, improving minerals recovery depends on maximizing collision frequencies. For a flotation process carried out under turbulent flow conditions, many investigators use the following model,

$${Z}_{12} = 5. {N}_{1} {N}_{2} {d}_{12}^{2} \sqrt{{\overline{U}}^{2} + {\overline{{U}_{2}}}^{2}} \qquad [ 2 ]$$

in which Z₁₂ is the collision frequency, N1 and N2 are the number or densities of mineral particles 1 and air bubbles 2, respectively, \sqrt{ū₁²} and \sqrt{ū₂²} are the corresponding RMS velocities, and d₁₂ is the sum of the bubble and particle radii. Eq. [2] is referred to as a hard-core collision model since collision occurs when two particles are within the distance of d₁₂, which is known as collision diameter.

One can then write a flotation model as follows,

$$\begin{matrix}\frac{d {N}_{1}}{d t} = - {Z}_{12} P \\ = - 5. {N}_{1} {N}_{2} {d}_{12}^{2} \sqrt{{\overline{{U}_{1}}}^{2} + {\overline{{U}_{2}}}^{2}} P \\ = - {k}_{p} {N}_{1} {N}_{2}\end{matrix} \qquad [ 3 ]$$

in which P is the probability of flotation. Eq. [3] suggests that flotation rate (dN₁/dt) is proportional to N₁N₂ and its rate constant (kₚ) is given by,

$${k}_{p} = 5. {d}_{12}^{2} \sqrt{{\overline{{U}_{1}}}^{2} + {\overline{{U}_{2}}}^{2}} P \qquad [ 4 ]$$

Thus, flotation may effectively be a second-order reaction, but can be treated as a pseudo first-order reaction if N₂ is treated as part of the rate constant. In this latter case, the first-order flotation rate constant (k′ₚ) may be given as,

$${k}_{p}^{'} = 5. {N}_{2} {d}_{12}^{2} \sqrt{{\overline{{U}_{1}}}^{2} + {\overline{{U}_{2}}}^{2}} P . \qquad [ 5 ]$$

The probability of flotation (P) in Eq. [3] is a product of the probabilities of different subprocesses as follows,

$$P = {P}_{c} {P}_{a} ( 1 - {P}_{d} ) . \qquad [ 6 ]$$

in which P_{c}, Pₐ, and P_{d} represent the probabilities of bubble-particle collision, attachment, and detachment, respectively. P_{c} can be close to 1 under conditions of hard-core collision, which may be the case of infinitely large Stokes numbers. A more realistic model may be the one derived for streamline collision,

$${P}_{c} = \frac{3}{2} {( \frac{{d}_{1}}{{d}_{2}} )}^{2} [ 1 + \frac{3}{16} ( \frac{Re}{1 + 0.249 {Re}^{0.56}} ) ] . \qquad [ 7 ]$$

in which d₁ and d₂ are the particle and bubble diameters, respectively, and Re is the Reynolds number.

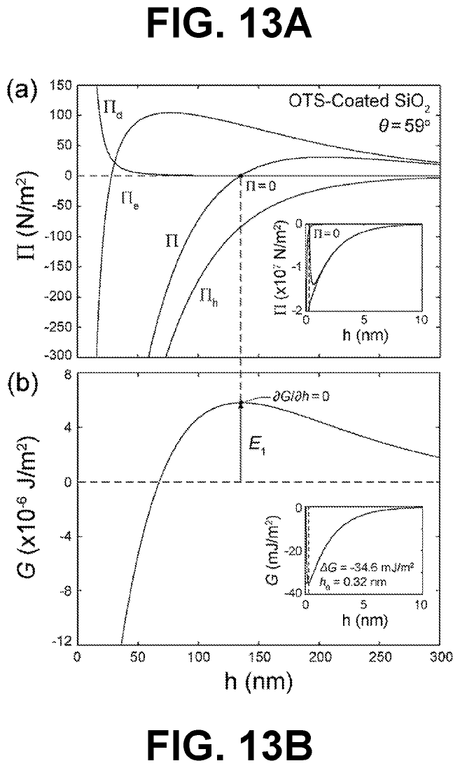

In the present work, the values of Pₐ have been calculated using the following model,

$${P}_{a} = exp ( - \frac{{E}_{1}}{{E}_{k}} ) . \qquad [ 8 ]$$

in which E₁ is the energy barrier for bubble-particle attachment, and Eₖ is the kinetic energy of the particle at the critical rupture thickness (h_{c}). The kinetic energy should increase as a it approaches closer to bubble surface. As will be shown in FIGS. 13A and 13B, the attractive hydrophobic force increases sharply with decreasing separation distance (h); therefore, its kinetic energy should accelerate with decreasing h. At h_{c}, Eₖ becomes strong enough to overcome E₁, causing the TLF to rupture and resulting in the formation of a finite contact angle. Eq. [8] is analogous to the Arrhenius equation and E₁ is equivalent to the activation energy. Force barriers against film rupture have been considered in the same vein. The rupture process occurring under conditions of zero force barrier has been referred to as “unhindered rupture,” indicating the importance of controlling E₁ to increase flotation kinetics.

In the present work, the values of Eₖ have been obtained using the following relation,

$${E}_{k} = \frac{1}{2} {{m}_{1} ( {\overline{U}}_{1 , {h}_{c}} )}^{2} . \qquad [ 9 ]$$

in which m₁ is the particle mass, and Ū_{1,h}_{_{c}} is the RMS velocity of particle 1 at the critical film thickness at which the thin liquid film (TLF) of water between air bubble and particle ruptures. The following relation,

$${\overline{U}}_{1} = 0.4 \frac{{ε}^{4 / 9} {d}_{1}^{7 / 9}}{{υ}^{1 / 3}} {( \frac{{ρ}_{1} - {ρ}_{3}}{{ρ}_{3}} )}^{2 / 3} \qquad [ 10 ]$$

can be used to obtain the RMS velocities of particles. In Eq. [10], ε is the energy dissipation rate, d₁ is particle diameter, v is kinematic viscosity of water, ρ₁ is particle density, and ρ₃ is the density of water.

For calculating Pₐ using Eq. [8], the values of E₁ can be determined from the disjoining pressure (Π(h)) and Gibbs free energy (G(h)) isotherms in the manner described below. The former can be readily determined using the extended-DLVO theory,

$$\begin{matrix}Π ( h ) = {Π}_{d} ( h ) + {Π}_{e} ( h ) + {Π}_{h} ( h ) \\ = - \frac{{A}_{123}}{6 π {h}^{3}} - \frac{{εε}_{0} {κ}^{2}}{2 sin h ( κ h )} [ ( {ψ}_{1}^{2} + {ψ}_{2}^{2} ) cos ech ( κ h ) - 2 {ψ}_{1} {ψ}_{2} coth ( κ h ) ] + \frac{{C}_{1}}{2 π {D}_{1}} exp ( - \frac{h}{{D}_{1}} ) + \frac{{C}_{2}}{2 π {D}_{2}} exp ( - \frac{h}{{D}_{2}} )\end{matrix} \qquad [ 11 ]$$

in which the subscripts d, e, and h represent the vdW, EDL, and HP components of the disjoining pressure, all of which vary with the closest separation distance (h) between bubbles and particles. In Eq. [11], A₁₃₂ is the Hamaker constant, ψ₁ and ψ₂ are the double-layer potentials of mineral and air bubble, respectively, κ⁻¹ is the reciprocal Debye length; C₁, and C₂ are the short- and long-range hydrophobic force constants, respectively, and D₁ and D₂ are the corresponding decay lengths.

In flotation, Π_{d} is repulsive as A₁₃₂<0, which means that it takes energy to desorb the water molecules adsorbed on hydrophobic mineral surfaces by the attractive van der Waals force, create solid/air interfaces, and form finite (receding) contact angles. On hydrophilic surfaces, it will not be thermodynamically possible to desorb the water molecules as they are H-bonded. If both ψ₁ and ψ₂ are negative, as is usually the case in mineral flotation, Πₑ is also repulsive. The only surface force that can create a negative disjoining pressure is the HP force as has already been discussed. At present, there are no theoretical models that can predict Πₕ. The only option is to conduct surface force measurements and to construct the disjoining pressure isotherm (Π(h)).

Once the Π(h) isotherm is known, one can determine the free energy isotherm using the following relationship,

$$\begin{matrix}Δ G ( h ) = - {\int }_{h = ∞}^{{h}_{0}} Π ( h ) dh \\ = γ ( cos θ - 1 )\end{matrix} \qquad [ 12 ]$$

in which h₀ is the thickness of the α-film formed on the particle surface after a wetting film has ruptured to form a finite contact angle (θ), and γ is the interfacial tension at the air/water interface. Since E₁ represents the maximum in a free energy isotherm, one can determine its value using the following relationship,

$$\begin{matrix}Π = - {( \frac{\partial G ( h )}{\partial h} )}_{h = {h}_{c}} \\ = 0\end{matrix} \qquad [ 13 ]$$

or graphically using the Π(h) and G(h) isotherms at the critical rupture thickness (h_{c}) where the film ruptures as Π=0.

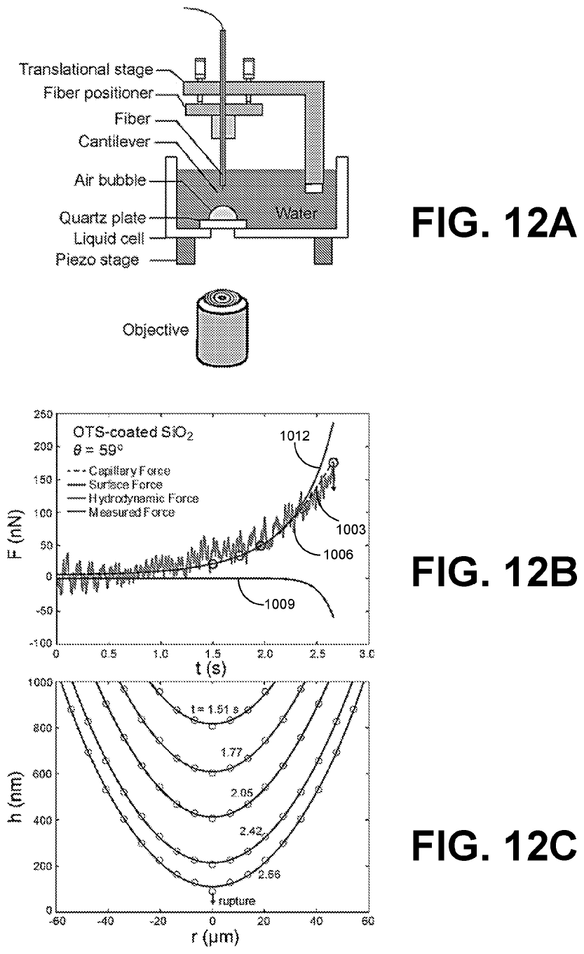

FIG. 12A depicts the force apparatus for deformable surfaces (FADS), which was used in the present work to measure the interaction forces between an air bubble and a hydrophobic surface. An air bubble, which was attached to a hydrophobic quartz plate, was pushed slowly against a cantilever spring by means of a piezo stage, while recording the optical fringes generated due to local curvature changes by means of a high-speed camera. The undersurface of the cantilever spring was coated with octadecyltrichlorosilane (OTS) to obtain θ=59°. The optical fringes were then analyzed offline to determine the changes in local curvature changes and hence the changes in capillary force (F(t)) using the following relationship,

$$F ( t ) = 2 π {\int }_{0}^{{r}_{max}} {p}_{c} ( r , t ) rdr \qquad [ 14 ]$$

in which p_{c}(r,t) is the capillary pressure at time t and radial location r, and rₘₐₓ is the radius of the TLF under consideration. FIG. 12B illustrates an example of force curves, which include capillary force, surface force, hydrodynamic force, and the forces measured by cantilever spring. Note in FIG. 12B that the capillary forces (dashed line 1003) measured using the curvature changes are close to the forces measured using the cantilever spring (oscillating line 1006), which validated the method of measuring the bubble-particle interaction forces by recording local curvature changes. The spatiotemporal film profiles presented in FIG. 12C were used to extract information to determine the curvature changes and calculate the capillary force using Eq. [14]. Substituting p_{c} from the following relationship,

$$p = {p}_{c} - Π \qquad [ 15 ]$$

into Eq. [14], one obtains the surface force (downward line 1009) and the hydrodynamic

force (upward curving line 1012) curves shown in FIG. 12B. Eq. [15], in which p is the hydrodynamic pressure that can be calculated using the Reynolds equation, represents the normal pressure balance across the TLF of water.

The Π(h) isotherm obtained in the manner described have been analyzed using the extended DLVO theory (Eq. [11]) and plotted in FIG. 13A (Π(h) isotherm obtained from the FADS data obtained for the wetting film of water formed on an OTS-coated silica surface with θᵣ=59°. As shown, both Πₑ and Π_{d} are repulsive, while Πₕ is attractive. By virtue of the negative Πₕ, Π becomes net negative at h_{c}<136 nm, at which point the TLF ruptures catastrophically to form a receding contact angle of θᵣ=59°. Substituting the disjoining

pressure isotherm into the Frumkin-Derjaguin isotherm (Eq. [12]), one can obtain the G(h) isotherm, which in turn can be used to obtain E₁=5.2×10⁻⁶ J/m². FIG. 13B shows the G(h) isotherm obtained using: A₁₃₂=−1.2×10⁻²⁰ J, ψ₁=−70 mV, ψ₂=−52 mV, κ⁻¹=96 nm, C₁=−275 mN/m, D₁=2 nm, C₂=−0.41 mN/m, D₂=49 nm.

For the purpose of simulation, the values of E₁ were calculated using the Derjaguin approximation,

$${\int }_{r = 0}^{r = {r}_{max}} Π ( h ) 2 π rdr = 2 π ( \frac{{R}_{1} {R}_{2}}{{R}_{1} + {R}_{2}} ) G ( h ) \qquad [ 16 ]$$

in which r is the radius of the TLF (or wetting film) confined between bubble and particle, and R₁ and R₂ are the radii of particle and bubble, respectively. In using Eq. [16], the double-exponential hydrophobic force term of the Π(h) isotherm (Eq. [11]) has been substituted by Eq. [1] to obtain,

$$\begin{matrix}Π ( h ) = {Π}_{d} ( h ) + {Π}_{e} ( h ) + {Π}_{h} ( h ) \\ = - \frac{{A}_{132}}{6 π {h}^{3}} - \frac{{εε}_{0} {κ}^{2}}{2 sin h ( κ h )} [ ( {ψ}_{1}^{2} + {ψ}_{2}^{2} ) cos ech ( κ h ) - 2 {ψ}_{1} {ψ}_{2} coth ( κ h ) ] - \frac{{K}_{132}}{6 π {h}^{3}}\end{matrix} \qquad [ 17 ]$$

By substituting Eq. [17] into Eq. [16], one can obtain a free energy isotherm, G(h), which in turn can be used to obtain E₁. An advantage of using Eq. [17] rather than Eq. [11] for modeling purpose is that the former has a single hydrophobic force constant, K₁₃₂ for the interaction between particle 1 and air bubble 2 in a water medium 3, while the latter has four parameters.

It has been shown than K₁₃₂ can be obtained from K₁₃₁ and K₂₃₂ using the geometric mean combining rule,

$${K}_{132} = \sqrt{{K}_{131} {K}_{232}} \qquad [ 18 ]$$

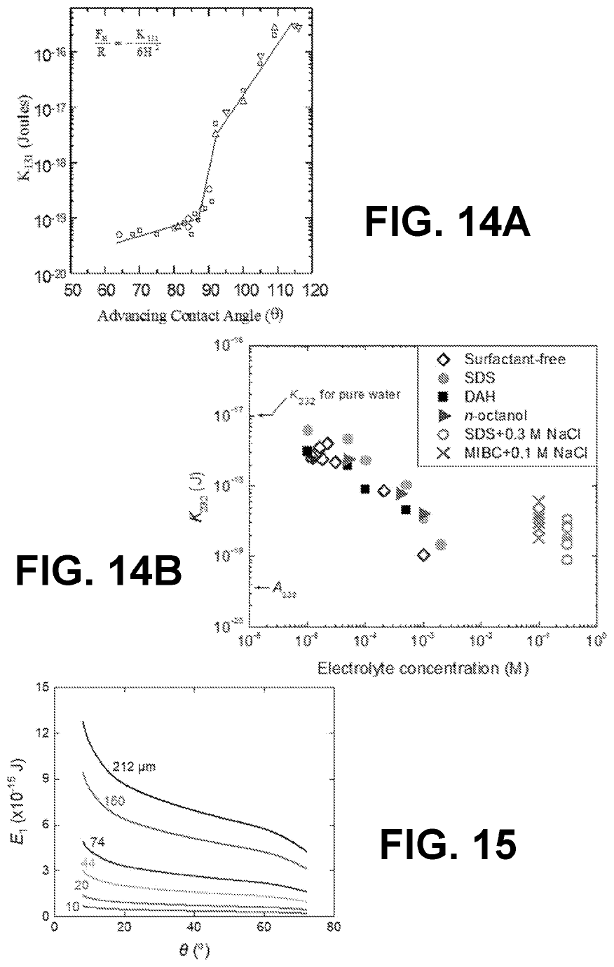

in the same manner as the Hamaker constants. FIGS. 14A and 14B show plots that can be used to obtain the values of hydrophobic force constants (K₁₃₁) between hydrophobic surfaces 1 in water 3 and the hydrophobic force constants (K₂₃₂) between two air bubbles 2 in water 3. FIG. 14A illustrates hydrophobic force constants (K₁₃₁) vs. contact angle (θ) in the TLFs confined between two solid surfaces and FIG. 14B illustrates hydrophobic force constants in the TLFs confined between two air bubbles.

Using the hydrophobic force constants obtained from FIGS. 14A and 14B, the values of E₁ have been calculated using Eq. [17] for the interaction between bubbles of 2.6 mm in diameter (d₂=2R²) and hydrophobic particles with varying contact angles (θ) and particle sizes (d₁=2R¹), with the results presented in FIG. 15. FIG. 15 illustrates the energy barriers (E₁) calculated using Eq. [16] for the interactions between bubbles of 2.6 mm diameter and particles of 10−212 μm in size. The surface chemistry parameters used for the calculations are: A₁₃₂=7.08×10⁻²⁰ J, ψ₁=−40 mV, ψ₂=−30 mV, κ⁻¹=96 nm, K₂₃₂=4.07×10⁻¹⁷ J. K₁₃₂ were obtained using Eq. [18]. As shown, E₁ decreases with increasing θ, showing that flotation rate should increase by making mineral particles more hydrophobic as is known in practice. The results show also that E₁ decreases with decreasing d₁, which arises from the Derjaguin approximation (Eq. [16]). This finding appears to contradict the known problems associated with fine particle recoveries in industry. One should note, however, that a decrease in particle size should cause a decrease in Eₖ too and hence Pₐ as can be seen from Eqs. [8] and [9]. A solution to increase Pₐ for fine particle flotation can be to increase the RMS velocity (Ū₁) of particles. As is known, fine particle flotation demands high energy input.

Modeling bubble-particle interactions as discussed above treated mineral particles as smooth spheres and/or surfaces for mathematic simplification. On the other hand, it has been shown that particle morphology plays an important role in bubble-particle interactions. It has been found that angular quartz particles have approximately four-times higher collection efficiencies than spherical glass particles. The sharp edges of quartz particles can help them penetrate the TLF, and thereby reduce the induction time. It has also been shown that particles with rough surfaces exhibit higher floatability possibly due to the

nucleation of nanobubbles and the large apparent contact angles. Eq. [15] may shed a light to the effect of particle morphology. Particle shape may increase the capillary pressure (p_{c}) and hence the hydrodynamic pressure (p), which in turn should affect the film thinning kinetics. Surface roughness should increase the apparent contact angles and hence increase the work of adhesion (Wₐ) by virtue of increased contact areas.

In the present work, the probability of detachment (P_{d}) of Eq. [6] has been determined using,

$${P}_{d} = exp ( \frac{- {W}_{a} + {E}_{1}}{{E}_{k}^{′}} ) \qquad [ 19 ]$$

in which Wₐ (=γπR₁²(1−cos θ)²) is the work of adhesion, and Eₖ′ is the kinetic energy of the particles due to turbulence. The latter has been determined using the following relation,

$${E}_{k}^{′} = \frac{1}{2} {{m}_{1} ( ( {d}_{1} + {d}_{2} ) \sqrt{ε / 𝓋} )}^{2} \qquad [ 20 ]$$

where ε is the energy dissipation rate in a flotation cell and v is the kinematic viscosity. Eq. [20] has been derived on the basis of the suggestion that particles detach from air bubbles in vortices rotating in a turbulent flow. The shear rate in a vortex has been given as \sqrt{ε/v}.

Substituting Eqs. [7], [8] and into Eq. [6] and subsequently into Eq. [5], one obtains the pulp phase flotation rate constant (k′ₚ) and hence the recovery (Rₚ). In using Eq. [5], the RMS velocity of bubbles can be obtained using the following relation,

$${\overline{U}}_{2} = {( {{C}_{0} ( ε {d}_{2} )}^{2 / 3} )}^{1 / 2} \qquad [ 21 ]$$

in which d₂ is bubble diameter and C₀ (=2.0) is a constant.

Froth phase recovery. When air bubbles are in close proximity to each other in a froth phase, the intervening water drains by gravity and/or capillary pressure (p_{c}). As the drainage continues to form a TLF of about 250 nm in thickness, film thinning is controlled by disjoining pressure (Π). In a horizontal film, the drainage stops at an equilibrium film thickness (hₑ) when Π becomes equal p_{c} and hence p becomes zero (see Eq. [15]). When Π becomes negative due to the appearance of a strong hydrophobic force, the film begins to thin again and ruptures catastrophically at a critical rupture thickness (h_{c}), where Π≤0, resulting in bubble coalesce and bubble coarsening. In flotation, frothers are used to dampen the hydrophobic force and stabilize foams and froths. Fine particles can also stabilize froth by increasing the local capillary pressures (p_{c,local}) around the particles adsorbed at the liquid/gas interface. When bubbles coarsen, less hydrophobic particles will drop off and return to the pulp phase due to the limited bubble surface area. Thus, bubble coarsening serves effectively as a built-in recycling/upgrading mechanism in flotation. On the other hand, excessive bubble coarsening can compromise the recovery and throughput.

It has been found that flotation recovery (R_{f}) decreases exponentially with the bubble residence time (τ) in froth phase, and derived the following relationship,

$${R}_{f} = exp ( - α τ ) \qquad [ 22 ]$$

which effectively represents the rate at which particles drop off from air bubbles and return to the pulp phase, with α representing the rate constant. For the reasons discussed above, the maximum froth phase recovery (Rₘₐₓ) may be derived as follows,

$${R}_{max} = \frac{{S}_{t}}{{S}_{b}} = \frac{6 {J}_{g} / {d}_{2 , t}}{6 {J}_{g} / {d}_{2 , b}} = \frac{{d}_{2 , b}}{{d}_{2 , t}} \qquad [ 23 ]$$

in which Sₜ and S_{b} are the bubble surface area fluxes at the top and the base of a froth phase, respectively, which turns out to be equal to the bubble size ratio between those at the base (d_{2,b}) and the top (d_{2,t}) of the froth phase at a given superficial gas rate (J_{g}). In this regard, Eqs. [22] and [23] may be combined as follows,

$${R}_{att} = \frac{{d}_{2 , b}}{{d}_{2 , t}} exp ( - α τ ) \qquad [ 24 ]$$

to represent the froth-phase recovery (Rₐₜₜ) due to attachment.

As is known, however, some of the finer particles are recovered by entrainment, which is proportional to the fractional water recovery (R_{w}) corrected for particle size (d₁) and the density difference (Δρ) between the particle and water. Thus, the overall froth phase recovery may be written as,

$${R}_{f} = {R}_{att} + {R}_{ent} = \frac{{d}_{2 , b}}{{d}_{2 , t}} exp ( - ατ ) + {R}_{w} exp ( - 0.0 \; 325 Δ ρ - 0.063 {d}_{1} ) \qquad [ 25 ]$$

in which Rₑₙₜ is the recovery due to entrainment. In an earlier work, the bubble size ratio was determined using a foam model. In the present work, the bubble-size ratio, or bubble coarsening, can be determined using the froth stability model.

Froths and foams are thermodynamically unstable. The role of frothers and particles is to extend their lifetimes by slowing down the rate of film thinning and rupture and thereby to minimize bubble coarsening by coalescence. The kinetics of film thinning (dh/dt) can be described by the Reynolds lubrication theory,

$$\frac{dh}{dt} = - \frac{2 {h}^{3} p}{3 μ {R}_{f}^{2}} \qquad [ 26 ]$$

in which p is the hydrodynamic pressure, μ is the water viscosity, and R_{f} is the film radius. According to Eq. [15], the driving force for film thinning (p) is the sum of the capillary pressure (p_{c}) and negative disjoining pressure (Π<0). In a flotation froth, small mineral particles in a lamella film create local capillary pressures (p_{c,local}) in the menisci around the particles adsorbed to the lamella film and thereby decrease the macroscopic p_{c} of the lamella film, causing p to decrease in the presence of particles in the lamella film of a froth phase and a decrease in drainage rate. The concept of p_{c,local} was introduced to explain the effects of d₁ and θ in determining the stability emulsions stabilized by particles. The role of frothers in flotation, on the other hand, is to dampen the hydrophobic force and thereby reduce the negative disjoining pressure.

Based on the concept discussed above, a model was derived that can predict the bubble size ratio as follows,

$$\frac{{d}_{2 , b}}{{d}_{2 , t}} = {[ exp ( - \frac{0.46 {n}_{f} {h}_{f}}{{J}_{g} {t}_{c}} ) ]}^{0.5} \qquad [ 27 ]$$

which can be substituted into Eq. [29] to predict froth recoveries (R_{f}). In Eq. [27], n_{f} is the number of the pentagonal faces of a bubble that rupture during coalescence, h_{f} the froth height, and t_{c} is the critical rupture time of a lamella film. In the present work, n_{f} has been used as an adjustable parameter, while t_{c} was predicted from the extended DLVO theory (Eq. [17]). Thus, Eq. [27] can be used to predict bubble coarsening as functions both physical and chemical parameters, which included both physical (h_{f}, J_{g}, d₁) and chemical (A₁₃₂, ψ₁, ψ₂, κ⁻¹ and K₁₃₂) parameters affecting froth stability.

In the present work, it is assumed that d_{2,b} is equal to the mean bubble size (d₂) in the pulp phase that were predicted using the bubble generation model,

$${d}_{2} = {( \frac{2.11 γ}{{ρ}_{3} {ε}_{b}^{0.66}} )}^{0.66} \qquad [ 28 ]$$

in which γ is the surface tension of water, ρ₃ is the density of water, and ε_{b} is the energy dissipation rate at the bubble generation zone (i.e., within the rotor-stator assembly). It was assumed that ε_{b} was 15-times larger than the energy dissipation rate of the overall dissipation rate (ε), which is usually about 1 kw/m³ for the large industrial flotation cells.

Of the various parameters used in the froth model, t_{c} may be most important. At d₁=35 μm, t_{c} increased with θ due to the increase in particle loading in the lamella films of the froth phase and hence increased local papillary pressure (p_{c,local}) (which in turn decreased the macroscopic capillary pressure (p_{c}) and hence the hydrodynamic pressure (p) in

accordance to Eq. [15]. This will slow down the kinetics of film thinning and thereby kinetically stabilized the froth. The model predicted that t_{c} reached a maximum at θ=70° and decreased at higher contact angle. It has been shown that froth is most stable at this contact angle. Regarding particle size effect, it has been predicted that t_{c} decreased with increasing d₁ due to increased particle detachment at θ=40°. The concept of p_{c,local} was introduced to explain the stability of emulsions stabilized by particles.

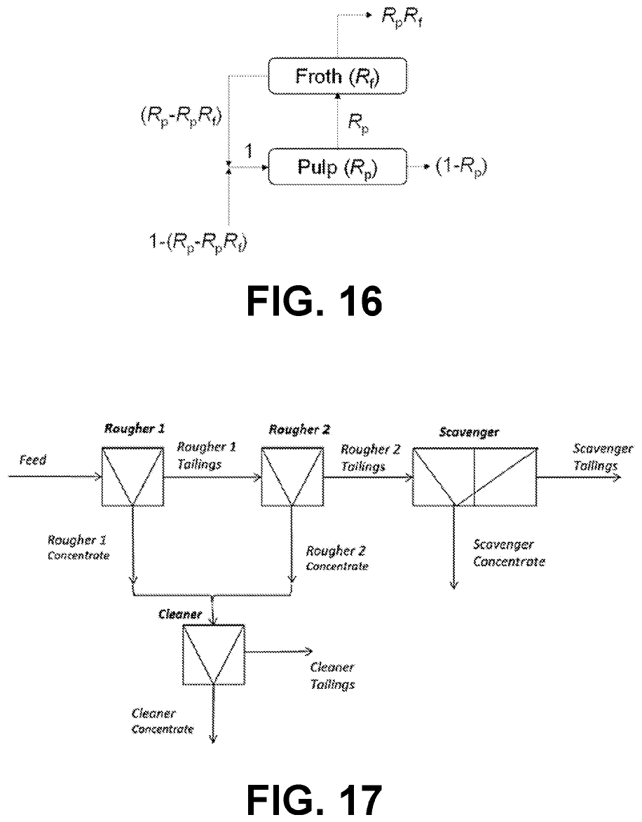

Overall flotation recovery. FIG. 16 shows the mass and flow balances across the pulp and froth phases of a well-mixed flotation cell, which gives the overall flotation recovery as follows,

$$R = \frac{kt}{1 + kt} = \frac{{R}_{p} {R}_{f}}{{R}_{p} {R}_{f} + 1 - {R}_{p}} \qquad [ 29 ]$$

in which R is the overall flotation recovery, k is the overall rate constant, Rₚ and R_{f} are pulp- and froth-phase recoveries, respectively, and t is the retention time. Eliminating Rₚ from Eq. [29] using a relationship between Rₚ and k′ₚ, i.e., Rₚ=k′ₚt/(1+k′ₚt), one obtains,

$$k = {k}_{p}^{′} {R}_{f} \qquad [ 30 ]$$

which can be used to calculate k from the values of kₚ′ determined using Eq. [5] and R_{f} using Eq. [25]. Note in FIG. 16 that the pulp phase and the froth phase are interconnected. The particles recovered from the pulp phase will play a role in determining R_{f}, while the particles that drop back from the froth phase can also affect Rₚ and kₚ′.

For a bank of n flotation cells, the bank recovery can be obtained using the following relation,

$$R = 1 - {( 1 - \frac{{R}_{p} {R}_{f}}{{R}_{p} {R}_{i} + 1 - {R}_{p}} )}^{n} \qquad [ 31 ]$$

provided that all cells have equal recoveries. It is difficult, however, to keep both the pulp and froth phase recoveries constant for various reasons, e.g., decreasing N₂ and h_{f} along the bank. Therefore, cell-to-cell recoveries were determined using the model developed in the present work.

The model equations presented here have been incorporated into a flotation simulator, which can predict flotation performance of a given ore sample under given operating conditions. The simulation process is initialized by entering the size-by-class feed liberation matrix (mᵢⱼ) for the ore sample. Based on the 2D liberation data, the contact angles of particles presented in each liberation class can be directly calculated using a weighted average method. It should be noted here that the current simulator does not convert the 2D liberation data into 3D, which may overestimate the liberation by about 10%. Generally, the contact angle of composite particles increases with their surface liberation. Knowing the contact angle and particle size, as well as a series of operating parameters such as feed rate, energy dissipation rate, aeration rate, froth height, etc., the simulator will automatically start calculating the flotation rate constants (kᵢⱼ) and recoveries (Rᵢⱼ) for the particles presented in each size and liberation classes using the equations shown in this section. Next, the flotation recovery (R) and rate constant (k) for all size and liberation fractions, and also the overall product grade will be computed based on the values of Rᵢⱼ's and mᵢⱼ's.

### Simulation

Flotation Tests. The flotation model developed here has been validated against previously reported continuous flotation test results reported. The tests were conducted using a mini plant, which consisted of twelve 1.7 L flotation cells in a rougher-scavenger-cleaner (RSC) circuit arrangement shown in FIG. 17. The tests were conducted on a copper ore from northern Brazil with a grade of 2.2% Cu at a feed rate of 110-118 g/min (about 7 kg/h). Each cell was equipped with a froth crowder and level sensor. The feed ore was ground to 85% passing 210 μm before use. Sodium amyl xanthate (NaAX) and sodium isopropyl methylene thionophosphate (NaIMTP) were used as collectors. Ethyleneglycol-propylene oxide ether and methyl isobutyl carbinol (MI BC) were used as frothers. The flotation test was run at 4 cm froth height.

The flotation feed was analyzed by QEMSCAN to obtain the size-by-class mass distribution matrix (mᵢⱼ) given in Table 6. It consisted of six particle sizes (i) and eleven surface liberation (j) classes as shown. Chalcopyrite was the major copper-bearing mineral with very small amounts of covellite, digenite, and malachite. Thus, the ore was essentially a binary ore consisting of chalcopyrite and siliceous gangue minerals.

TABLE 6
Size-by-class mineral liberation (mᵢⱼ) data for the feed to the pilot-scale copper flotation circuit

| Particle | | | | | | | | | | | | |
|---|---|---|---|---|---|---|---|---|---|---|---|---|
| Size i | Liberation Class j (%) | | | | | | | | | | | |
| (μm) | 0 | 0~15 | 15~25 | 25~35 | 35~45 | 45~55 | 55~65 | 65~75 | 75~85 | 85~93 | 93~100 | Total |
| 212 | 12.23 | 1.59 | 0.23 | 0.19 | 0.16 | 0.10 | 0.06 | 0.01 | 0.00 | 0.00 | 0.01 | 14.60 |
| 150 | 14.67 | 0.61 | 0.23 | 0.22 | 0.22 | 0.20 | 0.17 | 0.13 | 0.08 | 0.05 | 0.02 | 16.60 |
| 74 | 17.80 | 0.41 | 0.35 | 0.33 | 0.31 | 0.31 | 0.27 | 0.25 | 0.21 | 0.16 | 0.12 | 20.50 |
| 44 | 13.40 | 0.24 | 0.11 | 0.09 | 0.09 | 0.09 | 0.11 | 0.12 | 0.14 | 0.18 | 0.54 | 15.10 |
| 20 | 15.38 | 0.09 | 0.07 | 0.07 | 0.07 | 0.07 | 0.09 | 0.12 | 0.16 | 0.23 | 1.25 | 17.60 |
| 10 | 14.55 | 0.00 | 0.02 | 0.02 | 0.03 | 0.05 | 0.05 | 0.05 | 0.05 | 0.08 | 0.72 | 15.60 |
| Total | 88.03 | 2.95 | 1.01 | 0.91 | 0.88 | 0.82 | 0.73 | 0.68 | 0.63 | 0.70 | 2.67 | 100.00 |

dos Santos and Galery (2018b)

Feed Characterization. The mᵢⱼ matrix was analyzed to determine the contact angles (θⱼ) of the 11 different liberation (j) classes given in Table 6. It was assumed that free particles of chalcopyrite had a typical contact angle of θ=72° for sulfide minerals while the free gangue mineral particles had a contact angle of θ=8°. Based on experience in surface force measurement, it usually takes aggressive chemical treatment to dissolve organic contaminants in piranha solution at 90° C. to obtain zero contact. On the basis of these boundary conditions, the mean contact angles (θ̅ᵢⱼ) of the composite particles were calculated using the following equation,

$${\overline{θ}}_{ij} = {( {\prod }_{j = 1}^{n} {θ}_{j}^{{a}_{j} {b}_{j}} )}^{1 / {\sum }_{i = 1}^{n} {a}_{j}} = exp ( \frac{{\sum }_{j = 1}^{n} {a}_{j} {b}_{j} ln {θ}_{ij}}{{\sum }_{j = 1}^{n} {a}_{j}} ) \qquad [ 32 ]$$

in which θⱼ is the contact angle of the particles of liberation class j, aⱼ is the surface liberation, and bⱼ is an adjustable parameter. For a binary ore feed, Eq. [32] can be reduced to,

$${\overline{θ}}_{ij} = exp ( {a}_{1} {b}_{1} ln {θ}_{1} + {a}_{2} {b}_{2} ln {θ}_{2} ) \qquad [ 33 ]$$

in which a₁ is the degree of liberation based on the surface exposure of the copper-bearing minerals, a₂ represents the same for gangue minerals. In the present work, b₁=1.03 and b₂=1.0 were used as fitting parameters. In effect, these parameters represented locking factors to give higher weights for the liberated copper-bearing minerals than for the gangue minerals that are mostly liberated. Composite particles can appear as liberated particles; therefore, a locking factor greater than unity must be given for free particles.

In this approach, all particles in a given liberation class have the same contact angle of θ̅ᵢⱼ regardless of particle size. The weight percentages of the different particle size and liberation classes presented in the mᵢⱼ matrix gives a distribution of particles of different sizes (i) and liberation (j) classes in the flotation feed, which should determine the recoveries and grades of the flotation products obtained at different stages.

Simulation Results. The flotation simulator has been developed on the basis of the model by combining the pulp- and froth-phase models, both derived from first principles. The simulator is capable of predicting recovery vs. grade curves from the mineral liberation data that can be readily obtained using the liberation analyzers such as QEMSCAN, MLA, and TIMA. Many companies are using them to diagnose the performance of flotation circuits and improve separation efficiencies. A simulator that can readily predict both recoveries and grade will be a powerful tool for improving plant efficiency and maximizing throughput and product quality. The simulator also provides a pathway to developing flotation circuits directly from the mineral liberation data, subverting the needs for extensive optimization studies.

Predicting concentrate grades needs information on the driving force for the air bubbles to collect selectively the hydrophobic particles, e.g., xanthate-coated chalcopyrite. The driving force is the hydrophobic force that can cause the wetting film to thin, rupture, and dewet (or retreat), resulting in contact angle formation. These events occur in an accelerating speed owing to the hydrophobic force that is becoming stronger with decreasing film thickness (h) as shown in FIGS. 13A and 13B. No other surface forces other than the hydrophobic force can provide a sufficient energy to overcome the energy barrier (E₁) created the repulsive double-layer force. Even after the film rupture, the hydrophobic force becomes stronger to force the TLF of water to retreat and create a solid/vapor interface coated with one- or two-layers of water film known as α-film.

The K₁₃₁ values determined from the K₁₃₁ vs. B plot (FIG. 14A) and the K₂₃₂ values determined from the K₂₃₂ vs. frother concentration plot (FIG. 14B) were combined using Eq. [18] to obtain the K₁₃₂ values. In determining the K₁₃₁ values, we used the θ̅ᵢⱼ values estimated from the size-by-class liberation matrix given in Table 6. The K₁₃₂ determined in this manner were then used to determine the Π(h) isotherm (Eq. [17]), which was then substituted to Eq. [16] to determine E₁. Once E₁ is known, one can predict the first-order flotation rate constant (k′ₚ) in the pulp phase using Eq. [5] and subsequently determine the pulp-phase recovery (Rₚ) using the following relation,

$${R}_{p} = \frac{{k}_{p}^{′} t}{1 + {k}_{p}^{′} t} \qquad [ 34 ]$$

One can also determine the froth-phase recovery due to bubble-particle attachment (Rₐₜₜ) as follows,

$${R}_{att} = {R}_{max} exp ( - α τ ) \qquad [ 35 ]$$

which is as part of Eq. [25]. Substituting Rₘₐₓ of Eq. [35] with d_{2,b}/d_{2,t} of Eq. [27], one obtains,

$$\\ \begin{matrix}{R}_{att} = {[ exp ( - \frac{0.46 {n}_{f} {h}_{f}}{{V}_{g} {t}_{c}} ) ]}^{0.5} exp ( - α τ ) & [ 36 ]\end{matrix}$$

Substituting Eq. [36] into Eq. [25], one obtains the froth-phase recovery (R_{f}). Substituting Eqs. [25] and [34] into Eq. [29], one can determine the overall flotation recovery (R) for a single flotation cell. Substituting the same into Eq. [31], one can obtain the bank flotation recovery. In the present work, cell-to-cell recoveries were calculated rather than the bank recovery using Eq. [31]. Use of this equation requires that both Rₚ and R_{f} remain unchanged while a feed slurry flows through a flotation bank, which is difficult to achieve in industry.

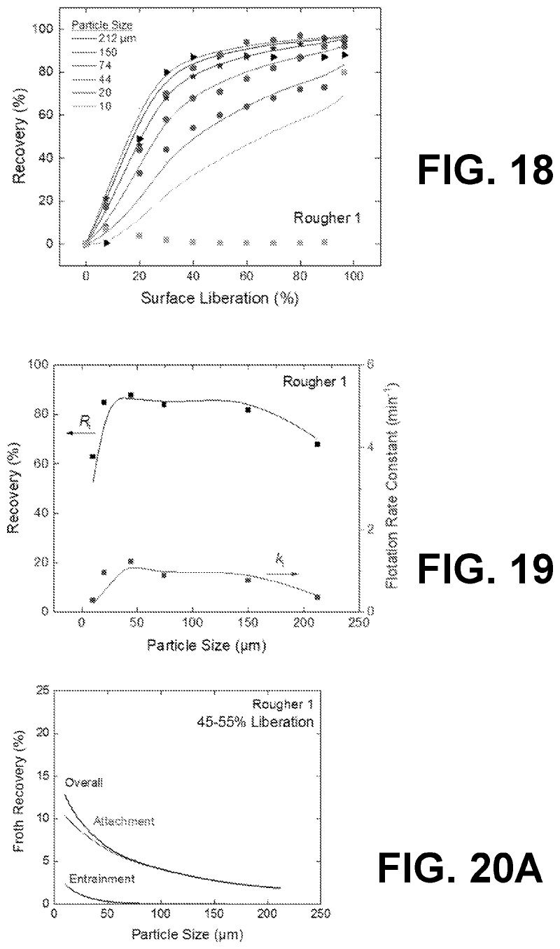

FIG. 18 shows the simulation results obtained using the algorithms described above. FIG. 18 illustrates a comparison of the simulated (lines) size-by-class recoveries (Rᵢⱼ) and the experimental data obtained from a pilot-scale flotation tests (points). The input data for the simulation was obtained from the previous work of dos Santos and Galery, and the results were compared with the experimental data. As shown, the size-by-class recoveries (Rᵢⱼ) increased with increasing surface liberation. The results show essentially that the larger the contact angles, the higher the recoveries are anticipated to be. An increase in particle contact angle (θ) should increase the hydrophobic force and hence reduce the energy barrier (E₁) for bubble-particle interaction, which should in turn increase the probability of bubble-particle attachment (Pₐ). This parameter may be most important in determining flotation selectivity and product grades. Note also that an increase in θ should increase the work of adhesion (Wₐ) and hence reduce the probability of detachment (P_{d}), which is very important in coarse particle flotation. The simulation results obtained with particles of d₁>20 μm are in reasonable agreement with the experimental data. However, the experimental results obtained with the −20 μm particles were substantially lower than predicted, which may be attributed to the small mass of the ultrafine particles in the samples analyzed by QEMSCAN.

FIG. 19 shows the size-by-size flotation recoveries (Rᵢ) and corresponding flotation rate constants (kᵢ). FIG. 19 illustrates the comparison of the simulated (lines) and size-by-class recovery data (points) obtained in a pilot-scale copper flotation tests as reported by dos Santos and Galery. The simulation results are in good agreements with the reported experimental data. It appears that the particles in the range of 44-150 μm exhibited higher flotation rate constants and hence higher recoveries, which is consistent with the well-recognized “elephant curve” phenomenon. The difficulties associated with coarse particles recovery may be attributed to the high probability of detachment (P_{d}) under turbulent flow conditions, while the difficulties associated with fine particles recovery is ascribed to the low probability of bubble-particle collision (P_{c}).

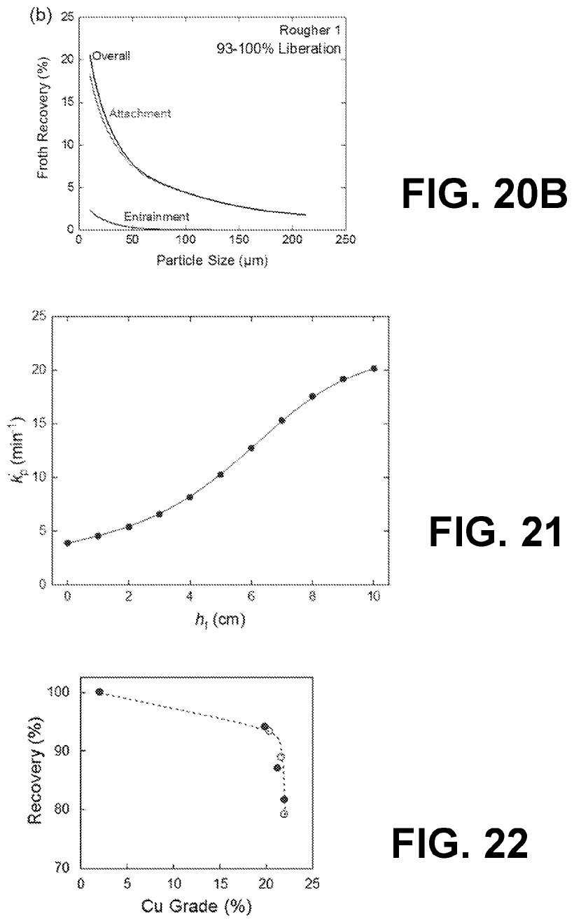

By virtue of using a froth model rather than a foam model for simulation, it is now possible to predict froth phase recoveries as functions of particle size and hydrophobicity. FIGS. 20A and 20B compare the simulated froth-phase recoveries for the particles with 45-55 and 93-100% liberation. FIG. 20A compares simulated froth recoveries for the particles with 45-55% liberated particles, and FIG. 20B compares simulated froth recoveries for 93-100% liberated particles. In both cases, the froth-phase recoveries decreased with increasing particle size, which can be attributed to particle detachment. Therefore, the recoveries should decrease with increasing particle size as shown. As bubble size increases due to coalescence, some particles must drop-off from bubble surface due to limited ‘parking’ area and return to the pulp phase. This phenomenon, known as particle drop-back, is a major limitation of flotation in terms of throughput. It is not surprising that the drop back is more serious with the less hydrophobic particles (FIG. 20A). It is also interesting to note that even the most hydrophobic particles are recovered by entrainment. Since the entrainment is proportional to water recovery, the recovery due to entrainment may be considered independent of particle hydrophobicity. The froth recovery (R_{f}) curves predicted by the model developed in the present work are comparable to those measured experimentally using the bubble load measurement (BLM) technique.

It is worthwhile to mention here that the predicted froth recoveries in the present work are much lower than those measured experimentally using the changing froth depth (CFD) technique. The large discrepancy between the two may be attributed to an inherent problem associated with the CFD technique, in which the froth recovery (R_{f}) is calculated using Eq. [30], i.e., R_{f}=k/kₚ′. kₚ′ is the collection zone (pulp phase) rate constant and k is the overall flotation constant. In a continuously operated flotation cell, a series of k at different froth heights (h_{f}) is determined based on the overall recoveries (R) using Eq. [29], while kₚ′ is obtained by extrapolating the froth height to zero. The kₚ′ determined in this manner at h_{f}=0 may not be the same as the one obtained at a nonzero h_{f}. The reason is that changing h_{f} affects the amount of the materials that drop back from the froth phase to the pulp phase (see FIG. 16), which in turn leads to a change in kₚ′. In the present work, a series of simulations were run using the flotation model to obtain the values of kₚ′ at varied h_{f}. FIG. 21 illustrates the effect of froth height (h_{f}) on the pulp phase rate constant (kₚ′). k_{c} was predicted using a flotation model using the mineral liberation data shown in Table 6. As shown, kₚ′ increases with increasing h_{f}, for which the CFD method always underestimates kₚ′ and hence overestimates R_{f} according to Eq. [30]. Furthermore, the extrapolating procedure in the CFD technique can induce large uncertainties in determining the value of kₚ′ at h_{f}=0, which also makes the CFD technique unreliable. The problems of the CFD technique presented here are consistent with those criticisms reported by other researchers, who recognized that the froth recoveries were generally overpredicted by the CFD technique. It has also been pointed out that the CFD technique could disturb the overall cell performance and the downstream flotation cells.

FIG. 22 shows the grade vs. recovery curves constructed by simulation for the flotation of a copper ore in a mini pilot plant. FIG. 22 compares the simulated recovery vs. grade curve (dashed line) and the experimental data (filled circles). The curves were drawn along the four sets of grades and recoveries: feed, first rougher, second rougher, and cleaner. The last three points drawn in open circles were simulated. Thus, drawing a curved line through the four points represent a simulated recovery vs. grade curve for the mini pilot plant operation. There is a reasonable fit between the simulated and experimental data. Table 7 shows a more detailed comparison between the simulated and experimental results. In general, there are good agreements between the simulated and experimental data in both recoveries and grades. Significant discrepancies are observed with the grades of the scavenger concentrate and cleaner tails. The discrepancy may be ascribed to the relatively small amounts of copper in the scavenger concentrate and the cleaner tails.

TABLE 7
Comparison between simulated and experimental data
obtained different stages of a pilot-scale copper flotation test

| | Recovery (%) | | Grade (%) | |
|---|---|---|---|---|
| Streams | Experiment | Simulated | Experiment | Simulated |
| Feed | 100.0 | 100.0 | 2.12 | 2.12 |
| Rg 1 Conc | 81.6 | 79.2 | 21.89 | 22.00 |
| Rg 1 Tails | 18.4 | 20.8 | 0.44 | 0.48 |
| Rg 2 Conc | 12.4 | 14.2 | 11.89 | 14.32 |
| Rg 2 Tails | 6.0 | 6.6 | 0.13 | 0.15 |
| Sc Conc | 2.8 | 3.3 | 2.29 | 8.12 |
| Sc Tails | 3.2 | 3.3 | 0.08 | 0.05 |
| Cl Conc | 87.0 | 88.9 | 21.38 | 21.67 |
| Cl Tails | 7.0 | 4.5 | 11.03 | 9.14 |

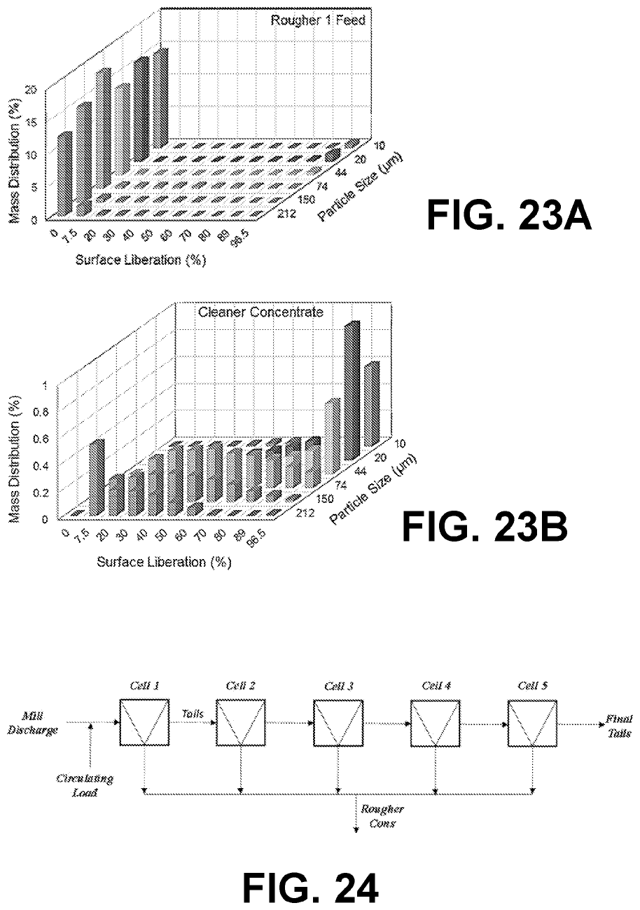

Distribution of different particle size and liberation classes in the final concentrate as predicted using the simulator are presented in FIGS. 23A and 23B. FIG. 23A shows the size-by-class mass distribution in Rougher 1 feed and FIG. 23B shows the distribution in cleaner concentrate. As shown, fully liberated particles show the highest mass percentages as expected. Still a large percentage of the particles of d₁=74 μm are composite particles most probably due to the mineralogical characteristics of the ore. It is surprising that a significant number of the largest particles (d₁=212 μm) were recovered despite the low degree of liberation (7.5%). This finding seems to support the theory that a 5% surface liberation may be the minimum threshold required for flotation. More recent studies showed that significant flotation is possible with a trace of floatable mineral exposed to the surface, which has an important implication to coarse particle flotation. Also shown in FIG. 23A is the mass distribution of particles in the flotation feed. Note that a vast majority of the particles exhibit zero surface liberation, while only a few percentages of the materials are fully liberated. Despite this seemingly unfavorable situation, small air bubbles selectively collected the copper-bearing minerals and produced a salable product with 21.4% Cu, which is why flotation still stands as the ‘best available’ separation technology for mineral fines.

The model-based simulator is designed to track the fates of the individual particles of different size and liberation classes going through a flotation circuit and thereby determine grade vs. recovery curves. With these capabilities, the simulator may be useful for processing ores of different liberation characteristics under different operating conditions, including those for grinding, reagent dosages, energy dissipation rate, circuit configuration, etc. The simulator has been tested successfully against the data obtained from a rougher-scavenger-cleaner flotation circuit of a mini-plant. The simulator may also be applied to more complicated flotation circuits that are used in industry. The model results can be used to modify or control process operations. For example, the number or density of air bubbles (N₂) can be adjusted as suggested by Eq. [3] (or other variables such as, e.g., froth height h_{f}) based upon the simulation results to improve efficiency of the process.

### E) Full Plant Modeling and Simulation

Flotation is regarded as the best-available separation process for the recovery of fine particles. A mined ore is ground typically to less than about 100 μm to liberate a target mineral from the rest, with the fine particles dispersed in an aqueous (or pulp) phase. A hydrophobizing agent (collector) is added to the pulp phase to selectively render the target mineral hydrophobic. Air bubbles are then introduced to the pulp to collect the hydrophobic particles on the surface, leaving the hydrophilic ones unattached. The bubble-particle aggregates formed in this manner rise in the pulp phase due to increased buoyancy, form a froth phase on top of the pulp phase and float into the launder to be recovered as a concentrate, while the hydrophilic particles leave the cell as tailings. Thus, flotation is essentially a hydrophobic-hydrophilic separation process.

When an air bubble in an aqueous phase approaches a surface, the bubble changes its local curvature, creating a capillary pressure that can cause the intervening liquid (water) to drain and thin. As the film thins to less than about 250-300 nm, the capillary pressure wanes as the film becomes more or less flat, while surface forces become stronger with decreasing film thickness, allowing the film thinning process to be controlled by the disjoining pressure (Π). As the film thins further to a critical thickness (h_{cr}), at which the disjoining pressure becomes negative, i.e., Π<0, the film ruptures catastrophically, creating a solid/air interface and forming a finite contact angle (θ) along the three-phase contact line, which is a prerequisite for flotation. Π has been measured in the thin liquid films (TLFs) formed on the gold surfaces coated with potassium amyl xanthate (KAX) using a modified Thin-Film Pressure Balance (TFPB) method. The results showed that the film thinning and rupture are controlled by the hydrophobic force, which increased with increasing θ. The same conclusion was drawn from the disjoining pressure measurements conducted on the TLFs of water formed on gold surfaces coated with potassium ethyl xanthate (KEX). These measurements were conducted using the Force Apparatus for Deformable Surfaces (FADS), which was more accurate than the modified TFPB.

Contact angle formation may be viewed as an incipient flotation, in which Π plays a decisive role in determining θ as shown by the Frumkin-Derjaguin isotherm,

$$\\ \begin{matrix}Δ G = - {\int }_{{h}_{∞}}^{{h}_{0}} Π ( h ) dh = {γ}_{LV} ( cos θ - 1 ) & [ 37 ]\end{matrix}$$

The disjoining pressure in Eq. [37] may be given as the sum of the Πₑ, electrical double-layer (EDL), Π_{d}, van der Waals (vdW), and Πₕ, hydrophobic (HP) forces as follows,

$$\\ \begin{matrix}Π ( h ) = {Π}_{d} ( h ) + {Π}_{e} ( h ) + {Π}_{h} ( h ) & [ 38 ]\end{matrix}$$

In bubble-particle interactions, the vdW force is always repulsive and so is the EDL force in most cases, while the HP force is always attractive. The HP force can be expressed either as an exponential force law or as a power law. The latter was used in the following form,

$$\\ \begin{matrix}\frac{{F}_{h}}{R} = - \frac{{K}_{131}}{6 {h}^{{}_{} 2}} & [ 39 ]\end{matrix}$$

in which Fₕ is the hydrophobic force, R is the radius of surfaces, h is the closest separation distance between two interacting surfaces, and K₁₃₁ is the hydrophobic force constant between two surfaces 1 in water 3. It has been shown that the HP constant (K₁₃₂) between particle 1 and air bubble 2 can be obtained from the following relationship,

$$\\ \begin{matrix}{K}_{132} = \sqrt{{K}_{131} {K}_{232}} & [ 40 ]\end{matrix}$$

in which K₂₃₂ is the hydrophobic force constant between two air bubbles in water. It has been shown that K₁₃₁ varies with θ, while K₂₃₂ varies with electrolyte (and frother) concentrations. An example of contact angles and hydrophobic forces controlling flotation separation has shown that the flotation rate constant increases exponentially with increasing surface liberation, which in turn controls the contact angles of composite particles in accordance with the Cassie-Baxter equation.

As bubbles rise in a froth phase, they become larger in size due to coalescence, forcing less-hydrophobic particles to drop off the surface due to the limited ‘parking’ area and the shockwaves created by the coalescence and drop back to the pulp phase. These mechanisms are responsible for the cleaning action of the froth phase. It would, therefore, be useful to predict bubble coarsening in the froth phase to predict product grades. A model was derived that can predict bubble coarsening as functions of particle size, hydrophobicity, particle loading, local capillary pressure, superficial gas velocity, etc. The bubble-coarsening model was combined with a pulp phase recovery model to develop a comprehensive flotation model that can be used to predict both recovery and grade. The model has been validated against the mini-plant data reported by dos Santos and Galery.

In the present work, operational data obtained from the rougher flotation circuit of a large porphyry copper ore processing plant has been used to validate the flotation model. The input to the simulation was the size-by-class liberation matrix. It is assumed that all of the particles in a given liberation class have the same contact angle, which in turn varies with the particle size as the surface liberation varies with particle size. Once the contact angles of particles are known, the values of K₁₃₂ are determined using Eq. [40] and Π using Eq. [38], which in turn is used to determine the kinetics parameters, e.g., energy barriers for bubble-particle attachment, and subsequently, the flotation rate constant as functions of particle size, bubble size, liberation, etc. The simulation results are in reasonable agreement with the plant survey data and provide new insights to improve the efficiency of flotation.

### Model

Pulp Phase Recovery. Flotation begins with the collision between bubbles and particles in the pulp phase of a flotation cell, followed by attachment. The kinetics of bubble-particle attachment may be represented as first-order rate equation,

$$\\ \begin{matrix}\frac{{dN}_{1}}{dt} = - {k}_{p} {N}_{1} & [ 41 ]\end{matrix}$$

in which N₁ is the number density of particles in the pulp phase and kₚ is the rate constant, which may be given as follows,

$$\\ \begin{matrix}{k}_{p} = 5. {N}_{2} {d}_{12}^{{}_{} 2} \sqrt{\overline{u} {}_{1}^{{}_{} 2} + \overline{u} {}_{2}^{{}_{} 2}} P & [ 42 ]\end{matrix}$$

where N₂ is the number density of bubbles in the pulp phase, d₁₂ is the collision radius, which is the sum of the radii of a bubble and a particle of interest, \sqrt{ū₁²} and \sqrt{ū₂²} are the corresponding RMS velocities. In Eq. [42], P is the probability of bubble-particle attachment, which is a product of the probabilities of collision (P_{c}), attachment (Pₐ) and not being detached (1−P_{d}) in the pulp phase, i.e., P=P_{c}Pₐ (1−P_{d}).

In the present work, the collision model,

$$\\ \begin{matrix}{P}_{c} = \frac{3}{2} {( \frac{{d}_{1}}{{d}_{2}} )}^{2} [ 1 + \frac{3}{16} ( \frac{Re}{1 + 0.249 {Re}^{{}_{} 0.56}} ) ] & [ 43 ]\end{matrix}$$

was used, in which d₁ and d₂ are the particle and bubble diameters, respectively, and Re is the Reynolds number for streamline collision. For the probability of attachment (Pₐ), the following expression can be used,

$$\\ \begin{matrix}{P}_{a} = exp ( - \frac{{E}_{1}}{{E}_{k}} ) & [ 44 ]\end{matrix}$$

in which E₁ is the energy barrier for bubble-particle attachment and Eₖ is the kinetic energy of particles in the pulp phase at h_{cr}. By analogy to the Arrhenius equation, Pₐ represents the fraction of the particles whose Eₖ=E₁. Eq. [44] suggests that only the particles with Eₖ>E₁ can be attached to air bubbles. Thus, it is necessary to keep E₁/Eₖ minimum to maximize Pₐ. One can determine E₁ from a free energy isotherm (G(h)), which is a function of disjoining pressure,

$$\\ \begin{matrix}Π = - \frac{{A}_{132}}{6 π {h}^{{}_{} 3}} - \frac{ε {ε}_{0} {κ}^{{}_{} 2}}{2 sinh ( κ h )} [ ( {ψ}_{1}^{{}_{} 2} + {ψ}_{2}^{{}_{} 2} ) cosech ( κ h ) - 2 {ψ}_{1} {ψ}_{2} coth ( κ h ) ] - \frac{{K}_{132}}{6 π {h}^{{}_{} 3}} & [ 45 ]\end{matrix}$$

in which A₁₃₂ is the Hamaker constant, ε the permittivity of vacuum, ε₀ is the dielectric constant of water, κ the reciprocal Debye length, and ψ₁, and ψ₂ are the surface (or ζ-) potentials of the particles and bubbles, respectively.

Derjaguin approximation relates the forces of interaction between two macroscopic surfaces of different geometries to the interaction energies. This relation was used to derive a relationship between a particle of radius R₁ and an air bubble of radius R₂,

$$\\ \begin{matrix}{\int }_{r = 0}^{r = ∞} Π ( h ) 2 π rdr = 2 π ( \frac{{R}_{1} {R}_{2}}{{R}_{1} + {R}_{2}} ) G ( h ) & [ 46 ]\end{matrix}$$

in which Π(h) and G(h) are the disjoining pressure and free energy isotherms, respectively, and r is the radial coordinate of the TLF. One can derive a functional form of G(h) and determine E₁ as follows,

$$\\ \begin{matrix}{{E}_{1} = {\int }_{r = 0}^{r = ∞} G ( h ) \vert}_{Π = 0} 2 π rdr & [ 47 ]\end{matrix}$$

which gives the value of energy barrier (E₁) in unit of Joules. Eq. [44] suggests that Pₐ=1 at E₁=0. What if the hydrophobic force continues to become stronger beyond this point? The answer should be that flotation kinetics continues to increase by virtue of the increase in the hydrodynamic pressure (p),

$$\\ \begin{matrix}p = {p}_{c} - Π & [ 48 ]\end{matrix}$$

which should increase with decreasing Π. If the disjoining pressure becomes more negative by increasing the hydrophobic force using a stronger collector, p will increase and hence facilitate the kinetics of film thinning and bubble-particle attachment. Eq. [48] shows also that one can increase p by increasing p_{c}, which can be accomplished by using smaller air bubbles.

The detachment probability (P_{d}) is of the same form as Pₐ as follows,

$$\\ \begin{matrix}{P}_{d} = exp ( - \frac{{W}_{a} + {E}_{1}}{{E}_{k}^{{}_{} ′}} ) & [ 49 ]\end{matrix}$$

where Wₐ (=γ_{LV}πR₁²(1−cos θ)²) is the work of adhesion and E′ₖ is the kinetic energy available for bubble-particle detachment in the pulp phase. In general, Wₐ»E₁; therefore, one can minimize P_{d} by increasing θ and by not decreasing the surface tension of water (γ_{LV}) excessively for bubble generation. Thus, Eqs. [44] and [49] suggest that the higher the contact angle, the higher the Pₐ and (1−P_{d}) and hence the higher pulp phase recovery (Rₚ).

Froth Phase Recovery. Hydrophobicity also plays an important role in the froth phase of a flotation cell. As bubble surface area decreases due to coalescence, less-hydrophobic particles would drop off the bubbles, providing a froth cleaning mechanism. Bubble coalescence is, of course, the central issue in determining the stability of foams and froths. Froth stability is difficult to predict as particles act as ‘solid surfactants’ as is the case with Pickering emulsions. A model was derived that can predict bubble size enlargement (or coarsening) as follows,

$$\\ \begin{matrix}\frac{{d}_{2 , b}}{{d}_{2 , t}} = {[ exp ( - \frac{0.46 {n}_{f} {h}_{f}}{{J}_{g} {t}_{c}} ) ]}^{0.5} & [ 50 ]\end{matrix}$$

in which d_{2,b} and d_{2,t} represent the bubbles at the base and the top of a froth phase, respectively, n_{f} the number of the pentagonal faces of a bubble that rupture during coalescence, h_{f} the froth height, and t_{c} is the critical rupture time of a lamella film. Both n_{f} and t_{c} are functions of particle size (d₁), particle hydrophobicity (θ), and the hydrophobic force in lamella films. Therefore, hydrophobicity and hydrophobic force should play a role in determining the grades of froth products.

The froth stability model was derived assuming that the air bubbles coalesce when the disjoining pressure in the lamella film that is free of particles becomes negative, i.e., Π<0. It has been shown that at low surfactant (or frother) concentrations, the hydrophobic force is the major attractive force destabilizing foam films. Although Eq. [50] does not have d₁ as a parameter affecting bubble coarsening, it and particle loading in a lamella film affect the local curvatures of the menisci around the particles and hence the macroscopic capillary pressure (p_{c}) in the film. During the initial stages of film thinning, its kinetics is controlled by p_{c}, which can be readily predicted using the Young-Laplace and Reynolds lubrication theories. Thus, the effects of particle size, particle hydrophobicity, and particle loading have been embedded in t_{c}, which can be predicted from first principles.

A froth phase model has been developed to better understand the cleaning action of the froth and predict froth grades. The model was based on the premise that bubble coalescence introduces shocks and reduces bubble surface area, both of which encourage particles to detach from lamella films. He reported that froth grades increase with froth height in support of his premise that weakly attached particles drop off bubbles preferentially, resulting in an increase in froth grades. The variation in mineral grades with froth height was also reported, while it was shown that detachment occurs suddenly at the moment of coalescence.

A froth-phase recovery (R_{f}) model,

$$\\ \begin{matrix}{R}_{f} = \frac{{d}_{2 , b}}{{d}_{2 , t}} exp ( - α τ ) & [ 51 ]\end{matrix}$$

has been derived in which α is the rate constant of detachment and τ is the retention time of particles in the froth phase. The pre-exponential term effectively represents the maximum carrying capacity of the froth phase. Less hydrophobic particles, e.g., composite particles, would have a larger α than the fully-liberated hence more hydrophobic particles. Thus, the separation process in the froth phase relies on selective detachment, while the same in the

pulp phase relies on selective attachment. Eq. [51] suggests that a higher degree of bubble coarsening should result in a lower froth phase recovery but a higher froth grade. Also, the exponential term suggests that one can produce a higher-grade froth product by simply increasing the froth height.

### F) Results and Discussion

Liberation Characteristics of Plant Feed. The model predictions have been made on a rougher flotation bank of a large copper flotation plant. The plant has four parallel rougher banks, each consisting of five mechanically-agitated flotation cells, each with a volume of 4,500 ft³. FIG. 24 illustrates a five-cell rougher flotation bank with a circulating load consisting of a cleaner-scavenger tail. The throughput of the bank was 1,455 tons/hr of feed assaying 0.24% Cu. The rougher feed included a mill discharge and a cleaner-scavenger tail as a circulating load.

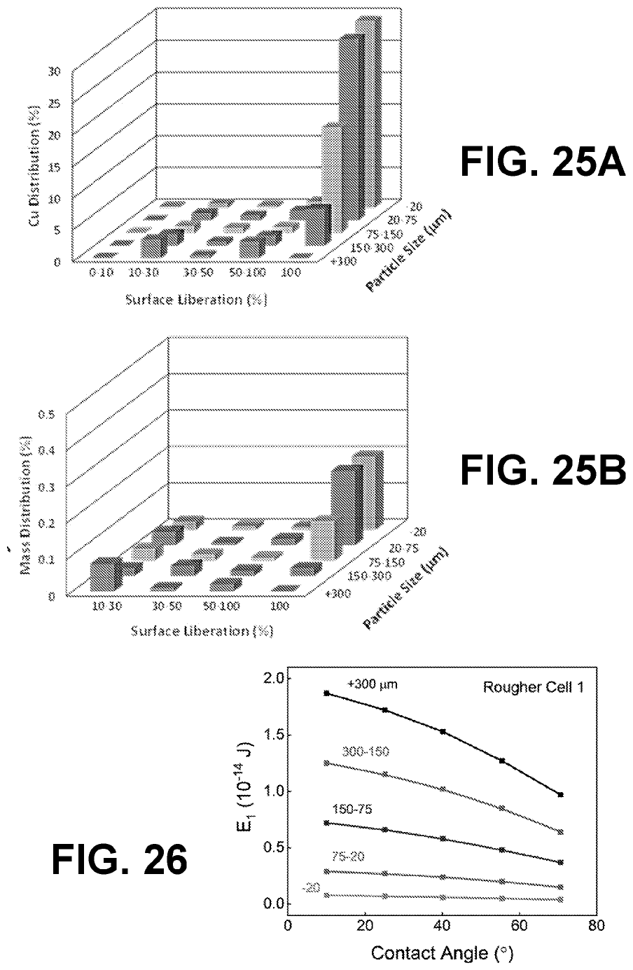

The company provided information on mineral liberation as obtained from the QEMSCAN and ICP-MS analyses. FIG. 25A shows the copper distribution (size-by-class copper distribution in the feed to the copper flotation bank) in the form of a 5×5 size-by-class matrix, which was converted to a mass distribution plot (size-by-class mass distribution (mᵢⱼ) used for simulation) shown in FIG. 25B. The conversion was made by giving 20% more weight to the fully-liberated particles as obtained by using QEMSCAN. This was necessary to match the copper distributions obtained using the 2D analysis with the copper distribution obtained by ICP analysis. The data given in FIG. 25B are also presented in Table 8 as a size-by-class liberation matrix (mᵢⱼ), which represented a mass distribution of particles of size i and liberation class j. The matrix does not include the data for the 0-10% liberation class as the numbers were much too large as compared to those of other liberation classes.

TABLE 8
Size-by-class mineral liberation matrix (mᵢⱼ) for rougher feed

| Particle Size, i | Liberation Class, j (%) | | | | | |
|---|---|---|---|---|---|---|
| (μm) | 0-10 | 10-30 | 30-50 | 50-100 | 100 | Total (%) |
| +300 | 18.63 | 0.05 | 0.01 | 0.02 | 0.00 | 18.71 |
| 150-300 | 21.52 | 0.02 | 0.03 | 0.02 | 0.02 | 21.60 |
| 75-150 | 18.44 | 0.03 | 0.02 | 0.01 | 0.11 | 18.60 |
| 20-75 | 21.95 | 0.04 | 0.01 | 0.02 | 0.20 | 22.22 |
| −20 | 18.62 | 0.02 | 0.01 | 0.01 | 0.20 | 18.87 |
| Total | 99.18 | 0.17 | 0.06 | 0.07 | 0.52 | 100.00 |

The ore contained chalcopyrite (0.72%) as the major copper-bearing mineral and a small amount (0.01%) of other copper minerals plus molybdenite (0.06%) and pyrite (2.45%). The major silicious gangue minerals included quartz (24.11%), K-feldspar (26.56%), and plagioclase (30.06%). It has been assumed for the purpose of simulation that chalcopyrite had a water contact angle of 70.6° while the gangue minerals have θ=10°. Under these assumptions, the contact angles (θ̅ⱼ) of composite particles have been calculated as follows,

$$\\ \begin{matrix}{\overline{θ}}_{j} = exp ( {a}_{1} {b}_{1} ln {θ}_{1} + {a}_{2} {b}_{2} ln {θ}_{2} ) & [ 52 ]\end{matrix}$$

in which a₁ and a₂ are the surface areas of chalcopyrite and silicious gangue minerals exposed on the surface of the sample briquettes prepared for image analysis, respectively, while b₁ and b₂ represent correction factors. The values of b₁=1.03 and b₂=1 have been used to improve the fit between the size-by-size recoveries obtained at the plant and those obtained by simulation using the composite contact angles obtained using Eq. [52]. The approach taken here is similar to using the Cassie-Baxter equation except that the contact angles obtained in this manner represent geometric mean contact angles for composite particles.

Energy Barrier. The energy barrier (E₁) of Eq. [44] represents the resistance to film thinning and rupture during the last stages of bubble-particle interaction, which is controlled by the disjoining pressure (or surface forces) in a wetting film. It has been suggested that the resistance arises from the repulsive EDL forces in wetting film and that E₁ should vary as ζ². The role of ζ-potentials in flotation is well recognized in the literature. Flotation of molybdenite reaches a maximum at a pH where the mineral acquires a zero zeta-potential. An advantage of using a cationic surfactant for the flotation of the silicious gangue minerals may be to minimize the ζ-potential. Coal can be floated without a collector or frother at high electrolyte concentrations due to double-layer compression. The use of a cationic polymer can greatly decrease the induction time by decreasing the repulsive EDL forces in a wetting film.

A more common way to reduce E₁ is to increase the hydrophobic force to counterbalance the repulsive EDL forces, which is accomplished by increasing θ using appropriate collectors. In general, the higher the contact angle, the higher the hydrophobic force, which should in turn give rise to lower E₁ and hence higher flotation kinetics and recoveries.

FIG. 26 illustrates an example of the effect of contact angles on the energy barriers (E₁) for the interactions between an air bubble and different sizes of particles. FIG. 26 shows the values of E₁ obtained using Eq. [47] using the (G(h)) isotherms,

$$\\ \begin{matrix}G ( h ) = \frac{1}{2 π} ( \frac{{R}_{1} + {R}_{2}}{{R}_{1} {R}_{2}} ) {\int }_{r = 0}^{r = ∞} Π ( h ) 2 π rdr & [ 53 ]\end{matrix}$$

derived from the Derjaguin approximation (Eq. [46]). Eq. [47] was used at h=h_{cr}, where Π=0. The values of her were obtained using Eq. [45] by setting Π=0 and using the values of the surface chemistry parameters and the bubble and particle sizes. The results presented in FIG. 26 were obtained using the following parameters: A₁₃₂=−7.08×10⁻²⁰ J, ψ₁=−20 mV, ψ₂=−40 mV, κ⁻¹=96 nm, and K₂₃₂=4.07×10⁻¹⁷ J, and R₂=0.75 mm. The values of K₁₃₁ were obtained from the θ̅ᵢⱼ values of the composite particles using the mineral liberation data (mᵢⱼ matrix) presented in Table 8 and FIG. 25B as a function of particle size i (=2R¹).

As shown, E₁ decreases with increasing θ̅ᵢⱼ and decreasing R₁. The decrease in E₁ with increasing contact angle can be attributed to the increase in hydrophobic force (or K₁₃₂) as has been shown previously as part of validating the flotation model described in the present communication against the experimental data obtained from a mini-plant.

The results presented in FIG. 26 are a manifestation of the Derjiaguin approximation. As Eq. [46] shows, a decrease in R₁ should cause a decrease in Π and hence E₁. Between R₁ and R₂, Π is more sensitive to the former as R₁«R₂ in flotation practice. This finding may seem counter-intuitive as Pₐ and flotation recovery should increase with decreasing particle size. Note, however, that a decrease in particle size should also decrease the kinetic energies (Eₖ) of particles. In fact, Eₖ should decrease as R₁⁻³ while Π decreases effectively as R₁⁻¹. The net effect of decreasing particle size should then be an increase in Eₐ/Eₖ, which should in turn cause a decrease in Pₐ. A solution to this problem may be to increase Eₖ, which can be achieved by increasing the energy dissipation rate or by improving the design of the rotor-stator mechanisms of a flotation cell.

Pulp Phase Recovery. Eq. [42] representing the first-order rate constant may be rewritten as,

$$\\ \begin{matrix}{k}_{p} = 5. {N}_{2} {d}_{12}^{{}_{} 2} \sqrt{\overline{u} {}_{1}^{{}_{} 2} + \overline{u} {}_{2}^{{}_{} 2}} {P}_{c} exp ( - \frac{{E}_{1}}{{E}_{k}} ) & [ 54 ]\end{matrix}$$

in which the pre-exponential term represents the collision efficiency while the exponential term represents in view of the Boltzman distribution law, the fraction of the particles whose kinetic energies (Eₖ) is the same or larger than the energy barrier (E₁) to film thinning and rupture. Eq. [54] is of the same form as the Arrhenius equation for chemical kinetics,

$$\\ \begin{matrix}k = A exp ( - \frac{{E}_{a}}{RT} ) & [ 55 ]\end{matrix}$$

In this regard, the E₁ of Eq. [55] may be regarded as the activation energy (Eₐ) required for a particle to penetrate a TLF of water and form a contact angle. Some of the particles will be detached and return to the aqueous phase. This important sub-process has been incorporated into Eq. [42] as part of the probability of overall flotation (P) in the form of (1−P_{d}), which represents the probability of a particle not being detached before entering the froth phase.

Flotation is sensitive to particle size and is efficient over the relatively narrow particle size range of approximately 20-150 μm. According to Eq. [46], E₁ is more sensitive to particle size (R₁) than to bubble size (R₂), because R₁«R₂. In the present work, Eqs. [46] and [47] were used to determine E₁ for the interactions between fully-liberated chalcopyrite particles of d₁ in the range of 10-300 μm with θ=70.6° and air bubbles with d₂=1.5 mm. The surface force parameters needed to calculate the Π(h) and G(h) isotherms were: A₁₃₂=7.08×10⁻²⁰ J, ψ₁=−20 mV, ψ₂=−40 mV, κ⁻¹=96 nm, and K₂₃₂=4.07×10⁻¹⁷ J, and K₁₃₁=5.07×10⁻²⁰ J. The results presented in Table 9 and FIG. 26 show that E₁ decreases with decreasing

TABLE 9
Effect of particle size on energy barrier and flotation probabilities

| d₁ | E₁ | Flotation Probabilities | | | |
|---|---|---|---|---|---|
| (μm) | 10⁻¹⁵ J) | P_{c} | Pₐ | 1-P_{d} | P |
| +300 | 0.4 | 0.002 | 0.567 | 0.785 | 0.0007 |
| 150-300 | 1.48 | 0.023 | 0.959 | 0.304 | 0.0066 |
| 75-150 | 3.68 | 0.015 | 0.994 | 0.103 | 0.0158 |
| 20-75 | 6.43 | 0.462 | 0.999 | 0.041 | 0.0188 |
| 0-20 | 9.7 | 0.823 | 1 | 0.015 | 0.0127 |

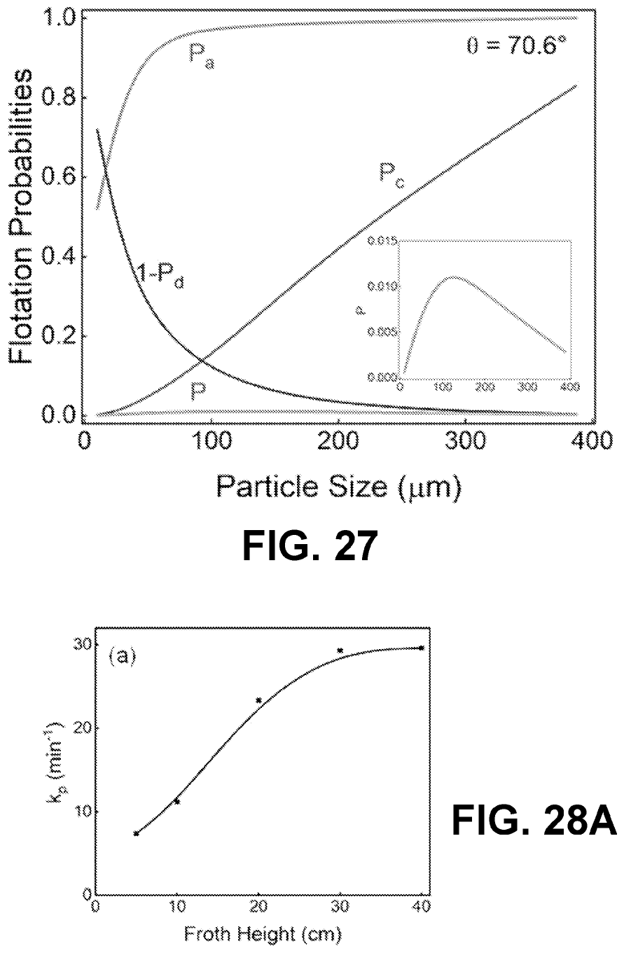

The values of E₁ obtained in this manner were then used to determine Pₐ and P_{d} using Eq. [44] and [49], respectively. The methods of determining Eₖ and Eₖ′ are described in the Appendix below. The values of P_{c}, on the other hand, were obtained using Eq. [43] from the particle and bubble sizes involved. Table 9 and FIG. 27 show the changes in P_{c}, Pₐ, (1−P_{d}), and P (for fully-liberated chalcopyrite particles in the first rougher cell). Note here that the values of the overall probability of flotation (P) decrease with decreasing particle size, providing an explanation for the difficulty of floating particles. The main cause for the low P for finer particles was the low probability of collision (P_{c}) as is well known. Fine particles follow the streamlines around larger bubbles, resulting in low values of P_{c}. One way to overcome this problem would be to decrease d₂ to increase (d₁/d₂)², which was the basis for the microbubble and nanobubble flotation. Still another way to improve fine particle flotation would be to increase Pₐ by increasing the kinetic energy Eₖ by increasing the energy dissipation rate in the pulp phase of a flotation cell as suggested by Eq. [44]. A decrease in E₁ by way of using a strong collector should also increase Pₐ and hence P to improve fine particle flotation. Also shown in FIG. 27 and Table 9 is that 1−P_{d}, representing the probability of not being detached, decreases sharply with increasing particle size, which in turn explains the difficulty in coarse particle flotation.

FIG. 27 shows that the probability of flotation (P) is very low throughout the entire particle size range considered. As shown, it is due to the low P_{c} and large P_{d} at the small and large particle size ranges, respectively. The P vs. d₁ plot presented as an inset shows that P reaches a maximum at d₁=150 μm, which is actually close to the upper particle size limit observed in copper flotation. The apparent discrepancy between the P vs. d₁ plot shown as inset and the usual flotation practice may be due to the fact that the P values represent what happens in the pulp phase, while the upper particle size limit of 150 μm observed in flotation practice is the consequence of what happens in both the pulp and froth phases. This discrepancy suggests that coarse particles are lost in the froth phase rather than in the pulp phase. It has been shown that coarse and less hydrophobic particles readily drop off bubbles as the bubble size increases due to coalescence.

Froth Phase Recovery. Two different methods of determining froth phase recoveries (R_{f}) have been reported in the literature. These include changing froth depth (CFD) and bubble-load method (BLM). In the former, R_{f} is determined by dividing the overall flotation rate constant (k) encompassing both the pulp- and froth-phase recoveries by the rate constant (kₚ) for the pulp-phase flotation recovery step at a given froth height (h_{f}), i.e.,

$$\\ \begin{matrix}{R}_{f} = \frac{k}{{k}_{p}} & [ 56 ]\end{matrix}$$

In this method, kₚ is determined by assuming that it is equal to the k at h_{f}=0, which is determined by extrapolating the values of k obtained at different froth heights. In the latter method, a specially designed probe is inserted vertically into the pulp phase to allow for the bubble-particle aggregates to rise through the pulp phase and be collected in a separate chamber so that the number of the particles recovered by selective attachment is determined. It has been shown previously that the simulation results are substantially lower than those reported by using the CFD method in the literature but are in reasonable agreement with those determined using the BLM method.

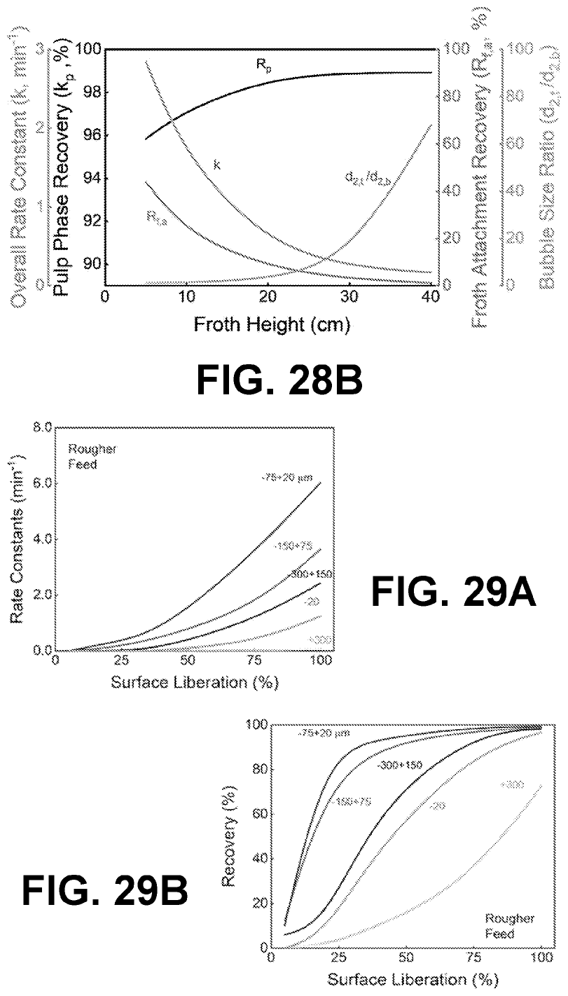

In the present work, the kₚ values were determined using Eq. [42] using the RMS velocities and the P_{c} values calculated from the equations given in the Appendix below, while the values of Pₐ and P_{d} values were calculated using Eqs. [44] and [49], respectively. The model predictions were made by varying the froth heights from 5 to 40 cm in the first cell of the rougher flotation bank (FIG. 24). The froth phase recovery model (Eqs. [50] and [51]) are designed such that the particles of lower surface liberation drop off bubbles at a lower h_{f} where bubble coarsening is less extensive. At a higher h_{f}, bubble size grows further to the extent that even the particles of higher surface liberation would drop off bubbles due to further limitations in ‘parking area.’ These constraints will result in an increase in the population of the particles of higher contact angles at a higher froth height, which in turn should give rise to a higher kₚ value as shown in FIG. 28A, which illustrated the effect of froth height in the first rougher cell on pulp phase rate constant. On the contrary, extrapolating the kₚ vs. froth height plot to h_{f}=0, kₚ will become small, which will in turn increase R_{f} in accordance with Eq. [56]. Thus, the CFD method overpredicts froth recoveries.

FIG. 28B further illustrates the various subprocesses taking place in a froth phase. FIG. 28B shows the effect of froth height in the first rougher cell on pulp phase recovery, froth phase attachment recovery, overall rate constant, and bubble size ratio. To begin with, bubble size increases with increasing froth height due to coalescence, causing the composite particles of lower surface liberation to drop back first due to their lower contact angles, which in turn causes the pulp phase recoveries (Rₚ) and hence the kₚ to increase as shown. This will also cause the froth phase recoveries due to attachment (R_{f}) to decrease in accordance with Eq. [56]. Since the overall flotation recovery (R) is a product of Rₚ and R_{f}, i.e., R=RₚR_{f}, the overall rate constant k should decrease along with the decrease in R_{f} as shown. On the other hand, a decrease in R_{f} should increase the froth grade (or the final product grade)—a process known as froth cleaning. Thus, the driving force for froth cleaning, which is the important function of flotation, is bubble coalescence. Although the bubble coalescence causes froth recoveries to decrease, it is needed for producing high-grade concentrates.

Size-by-Size Recoveries. FIGS. 29A and 29B show the size-by-class recoveries of the copper-bearing mineral particles present in the rougher flotation bank as predicted using the model described in the foregoing sections. FIG. 29A illustrates the effect of surface liberation in the rougher bank on simulated overall size-by-class rate constants for different particle sizes; and FIG. 29B illustrates the effect of surface liberation on overall size-by-class Cu recoveries. The simulation started with the size-by-class mineral liberation matrix (mᵢⱼ) presented in Table 8. The contact angles of the different liberation classes (θ̅ⱼ) were calculated using Eq. [52] assuming that θ=70.6° and 10° for the grains of free chalcopyrite and free silicious gangue, respectively. The contact angle data were used to determine the hydrophobic force constant (K₁₃₁) of Eq. [45] and subsequently the G(h) isotherms, which were used to determine the energy barriers (E₁) for bubble-particle interaction using Eqs. [46] and [47]. The E₁ values obtained in this manner were then used to determine kₚ using the following relation,

$$\\ \begin{matrix}{k}_{p} = 5. {N}_{2} {d}_{12}^{{}_{} 2} \sqrt{\overline{u} {}_{1}^{{}_{} 2} + \overline{u} {}_{2}^{{}_{} 2}} {P}_{c} ( 1 - {P}_{d} ) exp ( - \frac{{E}_{1}}{{E}_{k}} ) & [ 57 ]\end{matrix}$$

which is equivalent to Eq. [54]. The only difference between Eqs. [54] and [57] is that the former does not have a parameter P_{d} representing the probability of detachment. Eqs. [43] and [49] were used to predict the P_{c} and P_{d}, respectively. The values of kₚ obtained using Eq. [57] were then used to predict the pulp phase recovery (Rₚ) as follows,

$$\\ \begin{matrix}{R}_{p} = \frac{{k}_{p} t}{1 + {k}_{p} t} & [ 58 ]\end{matrix}$$

for a fully mixed flotation cell. The pulp phase recoveries obtained in this manner were then combined with the froth phase recoveries (R_{f}) obtained from Eq. [51] to determine the overall flotation recovery (R) using the following relation,

$$\\ \begin{matrix}R = \frac{{R}_{p} {R}_{f}}{{R}_{p} {R}_{f} + 1 - {R}_{p}} & [ 59 ]\end{matrix}$$

The overall rate constant (k) was then obtained using Eq. [56] from the values of kₚ and R_{f}. Both the k and R values presented in FIGS. 29A and 29B were obtained using the various operating parameters, e.g., J_{g}, h_{f}, and the air holdup (ε_{g}), etc., collected from the plant survey and the size-by-class liberation data presented in Table 8.

The various steps described above were repeated for each of the five flotation cells of the rougher bank sequentially to determine the values of kᵢⱼ and Rᵢⱼ for each element of the mᵢⱼ matrix given in Table 8. The bank recovery of the particle size and liberation class (Rᵢⱼ) was calculated using the following relation,

$$\\ \begin{matrix}{R}_{ij} = 1 - \frac{{t}_{ij} {T}_{ij}}{{f}_{ij} {F}_{ij}} & [ 60 ]\end{matrix}$$

in which fᵢⱼ and tᵢⱼ are the feed and tails grades of a class, respectively, and Fᵢⱼ and Tᵢⱼ are the feed and tails mass flow rates, respectively. Once the Rᵢⱼ values are known, one can readily obtain the values of kᵢⱼ assuming that each flotation cell was perfectly mixed.

In FIGS. 29A and 29B, the values of kᵢⱼ and Rᵢⱼ obtained in the manner described above are plotted vs. surface liberation. As anticipated, both kᵢⱼ and Rᵢⱼ increased with surface liberation, which can be attributed to the increase in θ̅ⱼ. An increase in contact angle should decrease E₁ as shown in FIG. 26 and hence kₚ as Eq. [57] suggests. An increase in contact angle should also help improve the coarse particles' recovery in the pulp phase by way of decreasing the probability of detachment (P_{d}) by virtue of increasing the work of adhesion (Wₐ), which is a function of contact angle (See Eq. [49]). P_{d} also plays an important role in the froth phase. Composite particles with lower surface liberations preferentially drop off the air bubbles in the froth phase and return to the pulp phase, which serves as an important mechanism by which froth grades improve. It is interesting to note here that upgrading a mined ore, which is the objective of flotation, relies on selective attachment in the pulp phase and selective detachment in the froth phase, both of which are controlled by contact angles.

The simulation results presented in FIGS. 29A and 29B show that both the kᵢⱼ and Rᵢⱼ are the highest at the particle size of −75+20 μm followed by the −150+75 μm size fraction. The particles larger than 150 μm show substantially lower recoveries, particularly for those above 300 μm. It has been reported that copper recoveries fall below 62% at d₁>150 μm due to the poor mineral liberation, which drops dramatically at larger sizes. The simulation result shows also that +300 μm particles can be recovered provided that they are sufficiently liberated. The kᵢⱼ=0.136 min⁻¹ for the fully liberated chalcopyrite particles with d₁=300 μm, which is large enough to give a 76% recovery at the retention of 23.28 min. In reality, coarse particles are poorly liberated and hence will have much lower recoveries than simulated.

The −20 μm particles also exhibited low kᵢⱼ and Rᵢⱼ values as shown in FIGS. 29A and 29B, respectively. As has already been noted, much of the difficulty associated with fine particle flotation arises from the low collision probability (P_{c}). It appears, however, that there is another important reason, that is, poor liberation even with the smallest particles present in the rougher feed. According to the size-by-class liberation matrix given in Table 8, a vast majority (98.7%) of the copper-bearing minerals in the −20 μm size fraction belong to the poorest liberation class of 0-10%. Only 0.2% of the materials are fully liberated. Furthermore, the mass of the particles may be too small to give rise to a high probability of attachment (Pₐ) and high values of kᵢⱼ and Rᵢⱼ. Much of the −20 μm particles are recycled back to the rougher flotation circuit as a circulating load, which may or may not be a good practice as will be discussed in the ensuing publication of this series.

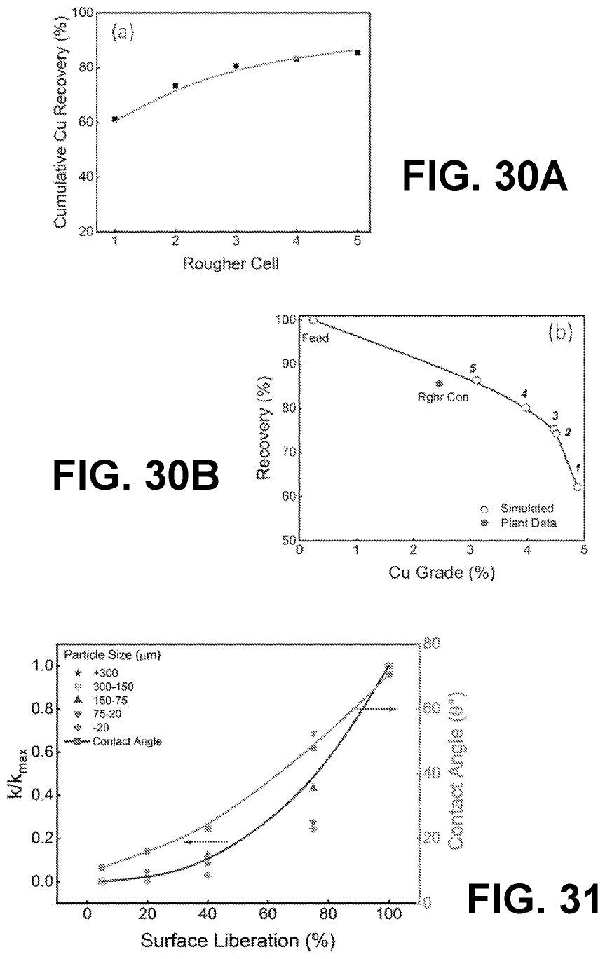

Predicting Recovery vs. Grade Curves. Table 10 shows the cumulative copper recoveries obtained by simulating the plant operation along the 5-cell rougher flotation bank. Also shown for comparison are the plant survey data. The two sets of data are in reasonable agreement, validating the simulator. The validation data set is also plotted in FIG. 30A, in which the line represents the simulation results, while the data points represent the plant data (cumulative cell-by-cell Cu recoveries).

TABLE 10
Comparison between plant data and
simulated values for each rougher cell.

| | Cu Distribution (%) | | Grade (%Cu) | |
|---|---|---|---|---|
| | | Plant | | Plant |
| Product | Simulated | Data | Simulated | Data |
| Cell 1 | 62.9 | 65.4 | 4.88 | — |
| Cell 2 | 11.8 | 12.6 | 3.27 | — |
| Cell 3 | 1.0 | 1.6 | 2.62 | — |
| Cell 4 | 4.8 | 1.7 | 1.44 | — |
| Cell 5 | 6.1 | 4.1 | 0.79 | — |
| Rougher Tail | 13.4 | 14.6 | 0.033 | 0.035 |
| Rougher Conc. | 86.6 | 85.4 | 3.11 | 2.46 |
| Feed | 100.0 | 100.0 | 0.24 | 0.24 |

Also shown in the table are the simulated grades of the froth products from each flotation cell. Unfortunately, the plant survey data did not include the product grades to be compared cell-by-cell with the simulation results. On the other hand, the simulated tailings grade of 0.033% Cu is very close to the actual tailings grade of 0.035% Cu.

Both the predicted grades and recoveries given in Table 10 are plotted in FIG. 30B to construct a recovery vs. grade curve. FIG. 30B illustrates the simulated grade-recovery curve for the rougher bank. Numbers 1, 2, 3, 4 and 5 represent the simulated cumulative grade and recovery (open circle) for the corresponding cell. The plant overall recovery is shown as Rghr Con (dot).

As shown, the rougher cell gives a high-grade froth product but at a low copper recovery. The grades of the froth products from the subsequent flotation cells are lower; however, each cell incrementally adds more copper-bearing minerals most likely in the form of composite particles, to the launder and the rougher concentrate. The net result of operating the 5-cell flotation bank is to produce the final rougher concentrate assaying 3.11% Cu at a recovery of 86.6% from a low-grade copper ore feed assaying 0.24% Cu. These simulation results are in reasonable agreement with the plant survey data: a rougher concentrate assaying 2.46% Cu at the 85.4% copper recovery. The objective of a rougher flotation bank is to maximize the recovery, which entails the recovery of composite particles.

Effect of Mineral Liberation on Contact Angle. In flotation, particle size and mineral liberation may be two important parameters affecting both the recovery and grade. The size-by-class flotation rate constants (kᵢⱼ) have been reported by analyzing the flotation products taken from a pilot-scale test work by means of a mineral liberation analyzer (MLA). It has been found that the rate constants (k) can be normalized by the maximum rate constant (kₘₐₓ) at a given size class, that is, the k/kₘₐₓ ratios obtained at different particle sizes in a given liberation class are practically same. It has also been shown that the k/kₘₐₓ ratio increased with increasing liberation, reaching unity for fully-liberated particles. These findings simply suggest that the higher the liberation, the higher the flotation rate and hence the recovery and grade as is anticipated.

FIG. 31 shows a k/kₘₐₓ vs. surface liberation plot on the basis of kᵢⱼ values obtained by simulation and presented in FIG. 29A. Also shown in the figure are the composite contact angles θ̅ⱼ of the particles in the five different liberation classes, i.e., 0-10, 10-30, 30-50, 50-100, and 100% surface liberations, using Eq. [52]. Thus, the increase in k/kₘₐₓ is simply a manifestation of increased contact angles at higher surface liberations.

The data presented in FIG. 31 show that the rate constants at the 50-100% surface liberations are not normalized as well as those obtained at the lower and higher degrees of liberation. The simulation data presented in FIG. 29A show that the k values exhibit substantially larger divergence at higher surface liberations or contact angles than at lower surface liberations. It appears that hydrodynamic parameters play more important roles at higher surface liberations or contact angles. Conversely, hydrodynamics would become immaterial in flotation, when the surface chemistry conditions, e.g., contact angles in particular, are not properly controlled.

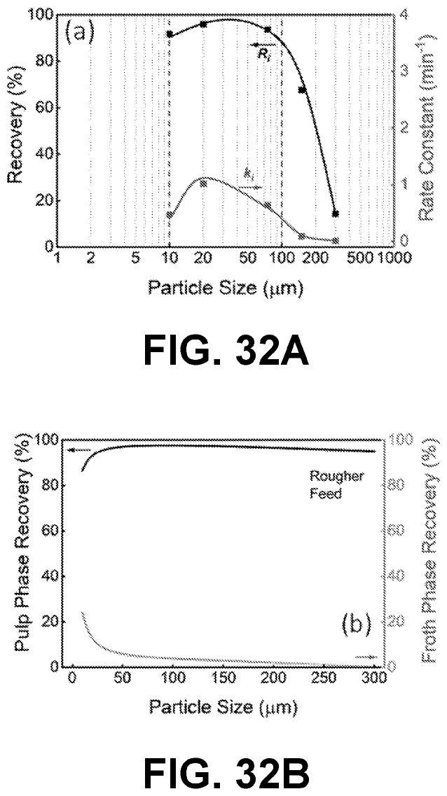

Coarse Particle Recovery. FIG. 32A shows the size-by-size recoveries (Rᵢ) of copper-bearing minerals for the rougher flotation bank as obtained by simulation. Also shown are the corresponding flotation rate constants (kᵢ). The recoveries are high at the 10-100 μm particle size range and drop above the optimal size range. The copper recovery predicted at +150 μm is 63%, which is close to what was previously reported. It is suggested that the sharp drop in recovery may be attributed to the dramatic decrease in liberation above this particular size for the flotation of porphyry copper ores.

The shape of the recovery vs. particle size curve shown in FIG. 32A is typical of most mineral flotation practices. The lines represent simulation results, while the points represent the plant survey data. The size-by-size recoveries and rate constants results show that high recoveries of copper can be achieved if the ore can be ground to less than 100 μm. Since grinding is the most energy-intensive unit operation in mineral processing, it would make sense to maximize the recovery at a coarse grind and regrind the low-grade rougher concentrate to improve the liberation and obtain higher concentrate grades.

Many investigators view that the coarse particles drop off air bubbles in the pulp phase of a flotation cell due to the high turbulence created by the rotor-stator mechanisms. The coarse particle flotation machines have been designed to address this problem by using different types of fluidized beds rather than the rotor-stator mechanisms for bubble-particle contacts. Furthermore, coarse particles attached to bubbles rise slower in the pulp phase. A method of using a combination of air bubbles and upward fluidization has been developed to facilitate the transport of coarse hydrophobic particles to the cell weir. A fluidized bed approach was developed to improve coarse particle flotation. A flotation machine was also developed, in which the segregation of bubbles from unattached particles is facilitated in inclined channels. All of these devices are designed to create quiescent conditions to minimize the probability of detachment.

FIG. 32B compares the pulp and froth phase recoveries as determined by using the simulator. The plot illustrates the effect of particle size on the pulp and froth phase recoveries in the first rougher cell. The pulp phase recoveries decrease with an increase in particle size at d₁>150 μm. Note, however, that the froth phase recovery is more sensitive to particle size. At d₁=300 μm, the coarse particle recovery approaches zero. The simulation results suggest that the problems associated with coarse particle flotation may be due to the high probability of detachment in the froth phase rather than in the pulp phase.

A flotation model developed from first principles has been validated against a rougher flotation circuit with a circulating load. The model has been developed based on the premise that bubble-particle interaction is driven by the hydrophobic force, which in turn made it possible to use contact angle and mineral liberation as model parameters. The input parameters to the simulator include the size-by-liberation matrix derived from the image analysis of the rougher feed and the various operating parameters such as contact angle, bubble size, retention time, energy dissipation rate, froth height, etc. In general, the simulation results are in good agreement with the plant survey data in both recoveries and grades. The recovery-by-particle size curve obtained in the first rougher cell shows a dropoff of particles above 150 μm most probably due to the sharp drops in liberation and froth phase recovery.

### G) Appendix

Root mean square (RMS) velocities of particles and bubbles. The RMS velocities of the particles were calculated using the following relationship,

$$\\ \begin{matrix}{\overline{U}}_{1} = 0.4 \frac{{ε}^{{}_{} 4 / 9} {d}_{1}^{{}_{} 7 / 9}}{{υ}^{{}_{} 1 / 3}} {( \frac{{ρ}_{1} - {ρ}_{3}}{{ρ}_{3}} )}^{2 / 3} & [ 61 ]\end{matrix}$$

where, d₁ is the particle diameter, ρ₁ and ρ₃ are particle and water densities, respectively, ε is the energy dissipation rate, and v is the kinematic viscosity of water.

The RMS velocities of the bubbles was obtained using the following relation,

$$\\ \begin{matrix}{\overline{U}}_{2} = {( {{C}_{0} ( ε {d}_{2} )}^{2 / 3} )}^{1 / 2} & [ 62 ]\end{matrix}$$

here, C₀ (=2) is a constant and, d₂ represents the bubbe diameter predicted from a bubble generation model,

$$\\ \begin{matrix}{d}_{2} = {( \frac{2.11 γ}{{ρ}_{3} {ε}_{b}^{{}_{} 0.66}} )}^{0.66} & [ 63 ]\end{matrix}$$

where γ is the surface tension, and ε_{b} is the energy dissipation rate at the bubble generation zone.

Kinetic energy of particles for bubble-particle attachment. The kinetic enegy of particles at the critical rupture thickness of the wetting film, Eₖ is given by:

$$\\ \begin{matrix}{E}_{k} = \frac{1}{2} {{m}_{1} ( {\overline{U}}_{1 , {h}_{cr}} )}^{2} & [ 64 ]\end{matrix}$$

where, m₁ is the mass of the particle,

$$\\ {\overline{U}}_{1 {,}_{{}_{} {h}_{cr}}}$$

is the RMS velocity of the particle at the critical rupture thickness (h_{cr}) of the wetting film.

Kinetic energy of particles for bubble-particle detachment. E′ₖ is the detachment kinetic energy due to turbulence in the pulp phase. The particle detachment has been considered due to the eddies formation in the turbulent flow to derive the following relationship for E′ₖ.

$$\\ \begin{matrix}{E}_{k}^{{}_{} ′} = \frac{1}{2} {{m}_{1} ( ( {d}_{1} + {d}_{2} ) \sqrt{ε / v} )}^{2} & [ 65 ]\end{matrix}$$

in which \sqrt{ε/v} is the shear rate in a vortex.

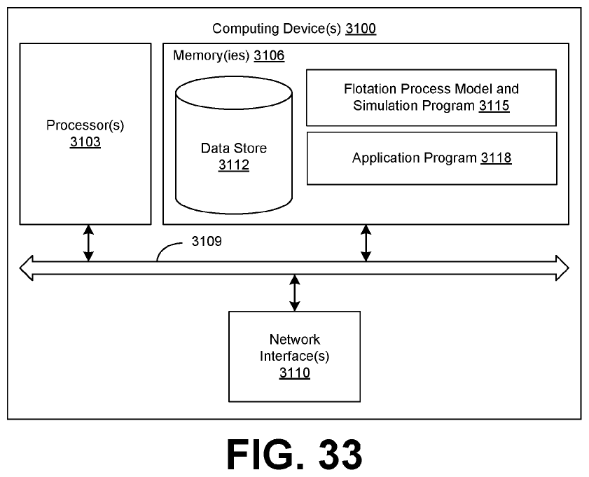

With reference to FIG. 33, shown is a schematic block diagram of a computing device 3100 that can be utilized for predicting perfusion images from non-contrast scans. In some embodiments, among others, the computing device 3100 may represent a mobile device (e.g., a smartphone, tablet, computer, etc.). Each computing device 3100 includes at least one processor circuit, for example, having a processor 3103 and a memory 3106, both of which are coupled to a local interface 3109. To this end, each computing device 3100 may comprise, for example, at least one server computer or like device. The local interface 3109 may comprise, for example, a data bus with an accompanying address/control bus or other bus structure as can be appreciated.

In some embodiments, the computing device 3100 can include one or more network interfaces 3110. The network interface 3110 may comprise, for example, a wireless transmitter, a wireless transceiver, and a wireless receiver. As discussed above, the network interface 3110 can communicate to a remote computing device using a Bluetooth protocol. As one skilled in the art can appreciate, other wireless protocols may be used in the various embodiments of the present disclosure.

Stored in the memory 3106 are both data and several components that are executable by the processor 3103. In particular, stored in the memory 3106 and executable by the processor 3103 are a flotation process model and simulation program 3115, application program 3118, and potentially other applications. Also stored in the memory 3106 may be a data store 3112 and other data. In addition, an operating system may be stored in the memory 3106 and executable by the processor 3103.

It is understood that there may be other applications that are stored in the memory 3106 and are executable by the processor 3103 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 3106 and are executable by the processor 3103. In this respect, the term “executable” means a program file that is in a form that can ultimately be run by the processor 3103. Examples of executable programs may be, for example, a compiled program that can be translated into machine code in a format that can be loaded into a random access portion of the memory 3106 and run by the processor 3103, source code that may be expressed in proper format such as object code that is capable of being loaded into a random access portion of the memory 3106 and executed by the processor 3103, or source code that may be interpreted by another executable program to generate instructions in a random access portion of the memory 3106 to be executed by the processor 3103, etc. An executable program may be stored in any portion or component of the memory 3106 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 3106 is defined herein as including both volatile and nonvolatile memory and data storage components. Volatile components are those that do not retain data values upon loss of power. Nonvolatile components are those that retain data upon a loss of power. Thus, the memory 3106 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (M RAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 3103 may represent multiple processors 3103 and/or multiple processor cores and the memory 3106 may represent multiple memories 3106 that operate in parallel processing circuits, respectively. In such a case, the local interface 3109 may be an appropriate network that facilitates communication between any two of the multiple processors 3103, between any processor 3103 and any of the memories 3106, or between any two of the memories 3106, etc. The local interface 3109 may comprise additional systems designed to coordinate this communication, including, for example, performing load balancing. The processor 3103 may be of electrical or of some other available construction.

Although the flotation process model and simulation program 3115 and the application program 3118, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the flotation process model and simulation program 3115 and the application program 3118, that comprises software or code can be embodied in any non-transitory computer-readable medium for use by or in connection with an instruction execution system such as, for example, a processor 3103 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the flotation process model and simulation program 3115 and the application program 3118, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 3100, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method of separating one type of fine particulate materials from other types of materials dispersed in an aqueous phase, comprising:
injecting an aqueous suspension of a cloud of small air bubbles of less than 500 microns into an aqueous phase comprising one type of fine particulate material, wherein the one type of fine particulate material is hydrophobized and the one type of fine particulate material is selectively collected by the air bubbles;
allowing the air bubbles loaded with the one type of fine particulate material to rise in the aqueous phase; and
collecting the air bubbles loaded with the one type of fine particulate material thereby obtaining a low-grade concentrate of the one type of fine particulate material.

2. The method of claim 1, comprising processing the low-grade concentrate of the one type of fine particulate material in a flotation process to generate a high-grade concentrate of the one type of fine particulate material.

3. The method of claim 1, comprising rendering the one type of fine particulate material selectively hydrophobized prior to inclusion in the aqueous phase.

4. The method of claim 3, wherein the one type of fine particulate material is rendered selectively hydrophobic by surface treatment.

5. The method of claim 4, wherein the surface treatment utilizes a long-chain surfactant as a hydrophobizing agent.

6. The method of claim 4, wherein when the one type of fine particulate material comprises a sulfide mineral, the surface treatment comprises adding a thiol-type reagent to the aqueous phase for hydrophobization.

7. The method of claim 1, comprising separating the one type of fine particulate material using the cloud of small air bubbles in a cyclonic flotation system.

8. The method of claim 1, comprising:
determining performance of a flotation plant for separation of the one type of fine particulate material from other types of fine particles, the performance determined based upon a flotation model that determines grade versus recovery curves for the one type of fine particulate material from mineral liberation characteristics; and
adjusting operation of the steps of claim 1 based upon the determined performance.

9. The method of claim 8, wherein operating conditions of the flotation plant are modified by optimizing recirculation of the one type of fine particulate material remaining in the aqueous phase.

10. A method of separating one type of fine particulate materials from other types of materials dispersed in an aqueous phase, comprising:
adding a recyclable hydrophobic liquid to an aqueous phase comprising one type of fine particulate material while being agitated, wherein the one type of fine particulate material is selectively hydrophobized and the one type of fine particulate material is selectively collected by the hydrophobic liquid;
allowing droplets of the hydrophobic liquid loaded with the one type of fine particulate material to rise in the aqueous phase and flow into a separate vessel;
agitating, in the separate vessel, the hydrophobic liquid comprising the one type of particulate material dispersed in the hydrophobic liquid to allow any aqueous phase that may have been entrained into the hydrophobic liquid to settle along with other types of materials that remain hydrophilic at a bottom of the separate vessel; and
separating the hydrophobic liquid from the one type of fine particulate material and recycling the hydrophobized liquid for subsequent use, thereby obtaining a high-grade concentrate of the one type of fine particulate material separated from the other types of materials.

11. The method of claim 10, comprising rendering the one type of fine particulate material selectively hydrophobic prior to inclusion in the aqueous phase.

12. The method of claim 11, wherein the one type of fine particulate material is rendered selectively hydrophobic by surface treatment.

13. The method of claim 12, wherein the surface treatment utilizes a long-chain surfactant as a hydrophobizing agent.

14. The method of claim 12, wherein when the one type of fine particulate material comprises a sulfide mineral, the surface treatment comprises adding a thiol-type reagent to the aqueous phase for hydrophobization.

15. The method of claim 10, wherein the recyclable hydrophobic liquid is selected from short-chain alkanes with carbon numbers less than seven, and an organic solvent whose boiling point is below the boiling point of water, allowing separation from the one type of fine particulate material by steam tripping or application of a low level of heat treatment for recycling and sustainability.

16. A method of separating one type of coarse particulate materials from other types of materials dispersed in an aqueous phase, comprising:
adding a hydrophobizing agent to an aqueous phase comprising coarse particulate materials to selectively render one type of coarse particulate material hydrophobic;
feeding the aqueous phase comprising the coarse particulate materials to a flotation cell configured to push the coarse particulate materials upward with accelerative forces and pull the coarse particulate materials downward with decelerative forces while allowing air bubbles to attach to the one type of coarse particulate material that is selectively hydrophobized and thereby reducing the apparent specific gravity of the one type of coarse particulate material and form a layer of froth phase;
allowing the coarse particulate materials in the flotation cell to form a layer of particulate materials with the one type of coarse particulate material on top of the layer of particulate materials;
allowing the one type of coarse particulate material to enter the froth phase via the accelerative forces, wherein the one type of coarse particulate material is upgraded via froth cleaning action provided by the froth phase; and
separating the one type of coarse particulate material from the froth phase and thereby obtaining the one type of coarse particulate material separated from other types of coarse particles.

17. The method of claim 16, comprising rendering the one type of coarse particulate material hydrophobic prior to inclusion in the aqueous phase.

18. The method of claim 17, wherein the one type of coarse particulate material is rendered selectively hydrophobic by surface treatment.

19. The method of claim 18, wherein the surface treatment utilizes a long-chain surfactant as a hydrophobizing agent.

20. The method of claim 18, wherein when the one type of coarse particulate material comprises a sulfide mineral, the surface treatment comprises adding a thiol-type reagent to the aqueous phase for hydrophobization.

21. The method of claim 16, comprising:
determining performance of a flotation plant for separation of the one type of coarse particulate material from other types of coarse particulate materials, the performance determined based upon a flotation model that determines grade versus recovery curves of the one type of coarse particulate material from mineral liberation characteristics; and
adjusting operation of the steps of claim 16 based upon the determined performance.
